(19) United States
(12) Patent Application Publication
(10) Pub. No.: US 2026/0259959 A1
(43) Pub. Date: Sep. 3, 2026

(54) DATA MODEL GENERATION APPARATUS, DATA MODEL GENERATION SYSTEM, AND METHOD OF GENERATING DATA MODEL

(71) Applicant: MITSUBISHI ELECTRIC CORPORATION, Tokyo (JP)

(72) Inventor: Takanobu YAGUCHI, Tokyo (JP)

(73) Assignee: MITSUBISHI ELECTRIC CORPORATION, Tokyo (JP)

(21) Appl. No.: 19/489,908

(22) PCT Filed: Jul. 19, 2023
(86) PCT No.: PCT/JP2023/026386

§ 371 Date: Dec. 4, 2025

(51) Int. Cl. G06F 18/241; G06N 3/09

(52) U.S. Cl. CPC G06F 18/241; G06N 3/09

(57) ABSTRACT

An object is to provide a technique capable of generating an appropriate data model without domain information of a detailed classification condition, for example. A data model generation apparatus includes: an attribute candidate generation part generating an attribute candidate from plural pieces of selection attribute information based on an evaluation value of the plural pieces of selection attribute information obtained by repetition of selection for the selection attribute information and calculation of the evaluation value of the selection attribute information; and a data model edit part updating a data model based on label information and the attribute candidate or based on the attribute candidate.

### TECHNICAL FIELD

The present disclosure relates to a data model generation apparatus, a data model generation system, and a data model generation method.

### BACKGROUND ART

Proposed is a data model (also abbreviated as “model” in some cases hereinafter) expressing a relationship between pieces of data using a graph structure for a purpose of improving searchability of information or visualizing the relationship between pieces of data. This data model is used for a social graph, a recommendation, a geographical space, and a master data management, for example.

In large-scale facilities such as water processing and a power generation plant, the number of plant components to be monitored is enormous. Thus, a scale of a data model for managing data and an alarm collected from the plant components gets large. There is a problem that a huge amount of work is required to generate, manage, and maintain such a data model by hand. There is also a problem that a relationship of data important for a user referring to a model is buried as a scale of the model is enlarged, and visibility of the model is lost.

In such problems, regarding the work, proposed are a method of generating a model based on existing domain information of an engineering diagram and a knowledge graph and a method of expanding an existing small-scale model. Regarding visibility of the model, proposed is a method of dividing constituent elements of the model in accordance with a predetermined classification or connecting and aggregating a related element, thereby improving visibility of the large-scale model.

For example, Patent Document 1 discloses a technique of associating a plant component extracted by applying an image recognition to an engineering diagram and the other engineering source based on a predetermined classification condition, thereby generating a data model.

### PRIOR ART DOCUMENTS

### Patent Document(s)

Patent Document 1: Translation of PCT Application No. 2022-524642

### SUMMARY

### Problem to be Solved by the Invention

However, the classification condition, that is to say, the domain information needs to be specifically designed in the conventional technique. Thus, there is a problem that design man-hours of the domain information increases when a hierarchical structure is achieved in accordance with plural types of classifications, for example. In the meanwhile, when the domain information is not specifically designed, there is a problem that it is difficult to achieve classification in a reflection of a taste of a user.

The present disclosure is therefore has been made to solve problems as described above, and it is an object to provide a technique capable of generating an appropriate data model without domain information such as a detailed classification condition, for example.

### Means to Solve the Problem

A data model generation apparatus according to the present disclosure includes: an attribute information extraction management part extracting a collection of attribute information from a data model to be monitored; a selection part selecting at least one partial collection of the attribute information as at least one piece of selection attribute information from the collection of the attribute information; an evaluation part calculating an evaluation value of the selection attribute information; an attribute candidate generation part generating an attribute candidate from the plural pieces of selection attribute information based on the evaluation value of the plural pieces of selection attribute information obtained by repetition of selection for the selection attribute information and calculation of the evaluation value of the selection attribute information; and a data model edit part updating the data model based on label information associated with a classification label representing the attribute candidate and the attribute candidate or based on the attribute candidate.

### Effects of the Invention

According to the present disclosure, the attribute candidate is generated from the plural pieces of selection attribute information based on the evaluation value of the plural pieces of selection attribute information obtained by repetition of selection for the selection attribute information and calculation of the evaluation value of the selection attribute information, and the data model is updated based on the label information and the attribute candidate or based on the attribute candidate. According to such a configuration, an appropriate data model can be generated without domain information such as a detailed classification condition, for example.

These and other objects, features, aspects and advantages of the present disclosure will become more apparent from the following detailed description and the accompanying diagrams.

### BRIEF DESCRIPTION OF DRAWINGS

FIG. 1 is a diagram illustrating a configuration of a data model generation apparatus according to an embodiment 1.

FIG. 2 is a flow chart illustrating an outline of a processing procedure of the data model generation apparatus according to the embodiment 1.

FIG. 3 is a diagram illustrating an example of attribute information extraction information and attribute information selection evaluation information according to the embodiment 1.

FIG. 4 is a diagram illustrating an example of data held by a data model information storage part according to the embodiment 1.

FIG. 5 is a flow chart illustrating a processing procedure of an attribute information extraction management part according to the embodiment 1.

FIG. 6 is a diagram for explaining an operation of the attribute information extraction management part according to the embodiment 1.

FIG. 7 is a diagram for explaining an operation of the attribute information extraction management part according to the embodiment 1.

FIG. 8 is a diagram for explaining an operation of the attribute information extraction management part according to the embodiment 1.

FIG. 9 is a diagram illustrating an example of information managed by the attribute information extraction management part according to the embodiment 1.

FIG. 10 is a flow chart illustrating a processing procedure of an attribute candidate generation part according to the embodiment 1.

FIG. 11 is a diagram for explaining an operation of the attribute candidate generation part according to the embodiment 1.

FIG. 12 is a diagram for explaining an operation of the attribute candidate generation part according to the embodiment 1.

FIG. 13 is a flow chart illustrating a processing procedure of a selection part according to the embodiment 1.

FIG. 14 is a diagram for explaining an operation of the selection part according to the embodiment 1.

FIG. 15 is a flow chart illustrating a processing procedure of an evaluation part according to the embodiment 1.

FIG. 16 is a diagram for explaining an operation of the evaluation part according to the embodiment 1.

FIG. 17 is a flow chart illustrating a processing procedure of a data model edit part according to the embodiment 1.

FIG. 18 is a diagram for explaining an operation of the data model edit part according to the embodiment 1.

FIG. 19 is a diagram for explaining an operation of the data model edit part according to the embodiment 1.

FIG. 20 is a diagram illustrating a configuration of a data model generation apparatus according to an embodiment 2.

FIG. 21 is a flow chart illustrating a processing procedure of an attribute candidate generation part according to the embodiment 2.

FIG. 22 is a diagram for explaining an operation of the attribute candidate generation part according to the embodiment 2.

FIG. 23 is a flow chart illustrating a processing procedure of a selection part according to the embodiment 2.

FIG. 24 is a diagram illustrating a configuration of a data model generation apparatus according to an embodiment 3.

FIG. 25 is a flow chart illustrating a processing procedure of an attribute candidate generation part according to the embodiment 3.

FIG. 26 is a flow chart illustrating a processing procedure of an evaluation learning part according to the embodiment 3.

FIG. 27 is a diagram illustrating a configuration of a data model generation apparatus according to an embodiment 4.

FIG. 28 is a diagram for explaining an operation of an attribute candidate generation part according to the embodiment 4.

FIG. 29 is a flow chart illustrating a processing procedure of an evaluation learning part according to the embodiment 4.

FIG. 30 is a flow chart illustrating a processing procedure of a selection learning part according to the embodiment 4.

FIG. 31 is a diagram illustrating a configuration of a data model generation apparatus according to an embodiment 5.

FIG. 32 is a flow chart illustrating a processing procedure of a selection learning part according to the embodiment 5.

FIG. 33 is a block diagram illustrating a hardware configuration of a data model generation apparatus according to another modification example.

FIG. 34 is a block diagram illustrating a hardware configuration of a data model generation apparatus according to another modification example.

### DESCRIPTION OF EMBODIMENT(S)

### Embodiment 1

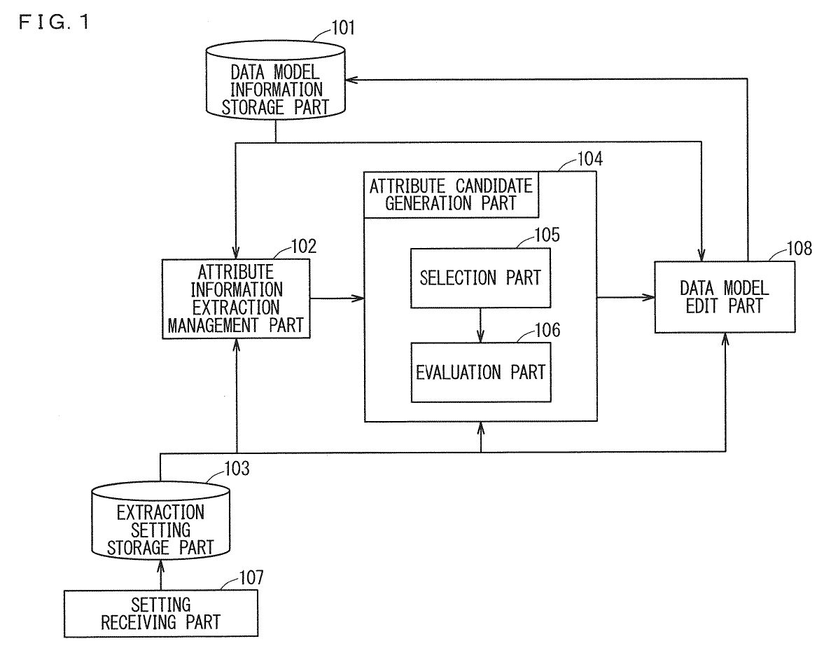

FIG. 1 is a diagram illustrating a configuration of a data model generation apparatus according to the present embodiment 1. The data model generation apparatus in FIG. 1 includes a data model information storage part 101, an attribute information extraction management part 102, an extraction setting storage part 103, an attribute candidate generation part 104, a setting receiving part 107, and a data model edit part 108. The attribute candidate generation part 104 includes a selection part 105 and an evaluation part 106.

As described hereinafter, the data model generation apparatus extracts a collection of attribute information from a data model to be monitored, aggregates the collection of the attribute information to generate an attribute candidate, and associates a classification label representing the attribute candidate with the attribute candidate, thereby updating the data model. Accordingly, a data model having visibility and searchability can be newly generated without domain information of a detailed classification condition, for example.

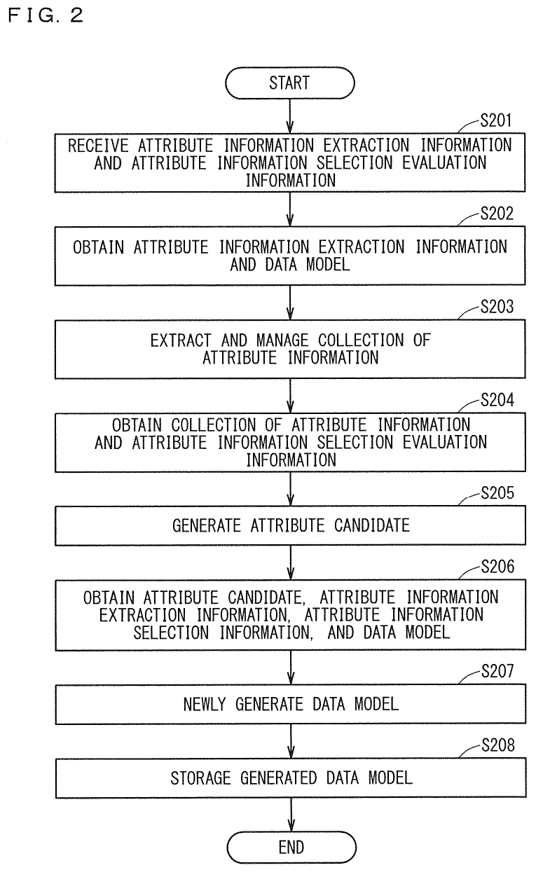

FIG. 2 is a flow chart illustrating an outline of a processing procedure of the data model generation apparatus according to the present embodiment 1.

In Step S201, the setting receiving part 107 receives information including attribute information extraction information and attribute information selection evaluation information from a user on the outside, and records the information in the extraction setting storage part 103. Although the details are described hereinafter, the attribute information extraction information is information for obtaining a data model or extracting a collection of attribute information from a data model, and the attribute information selection evaluation information is information for selecting attribute information or evaluating the selected attribute information.

In Step S202, the attribute information extraction management part 102 obtains the attribute information extraction information from the extraction setting storage part 103. The attribute information extraction management part 102 obtains a corresponding data model from the data model information storage part 101 based on designation of a data model name included in the attribute information extraction information.

In Step S203, the attribute information extraction management part 102 extracts the collection of the attribute information from the data model obtained in Step S202 based on the attribute information extraction information obtained in Step S202 and manages the collection thereof.

In Step S204, the attribute candidate generation part 104 obtains the collection of the attribute information managed by the attribute information extraction management part 102, and obtains attribute information selection evaluation information from the extraction setting storage part 103.

In Step S205, the attribute candidate generation part 104 selects a partial collection of the attribute information as selection attribute information from the collection of the attribute information based on the attribute selection evaluation information obtained in Step S204. That is to say, the attribute candidate generation part 104 selects a partial collection of the attribute information as selection attribute information from the collection of the attribute information based on the attribute selection evaluation information. Then, the attribute candidate generation part 104 evaluates the selection attribute information based on the attribute selection evaluation information obtained in Step S204, and generates an attribute candidate based on an evaluation result thereof.

In Step S206, the data model edit part 108 obtains the attribute candidate generated in the attribute candidate generation part 104 and the attribute information extraction information and the attribute information selection evaluation information held by the extraction setting storage part 103. The data model edit part 108 obtains a corresponding data model from the data model information storage part 101 based on designation of a data model name included in the obtained attribute information extraction information.

In Step S207, the data model edit part 108 newly generates a classification label representing an attribute candidate based on the attribute information selection evaluation information or the attribute candidate obtained in Step S206. Then, the data model edit part 108 associates the generated classification label with each attribute information included in the attribute candidate obtained in Step S206, and updates the data model obtained in Step S206, thereby newly generating a data model.

In Step S208, the data model edit part 108 stores the data model generated in Step S207 in the data model information storage part 101 and writes the data model over an original data model held in the data model information storage part 101.

The outline of the data model generation apparatus is described above. Next, each constituent element of the data model generation apparatus is described in detail.

### Setting Receiving Part

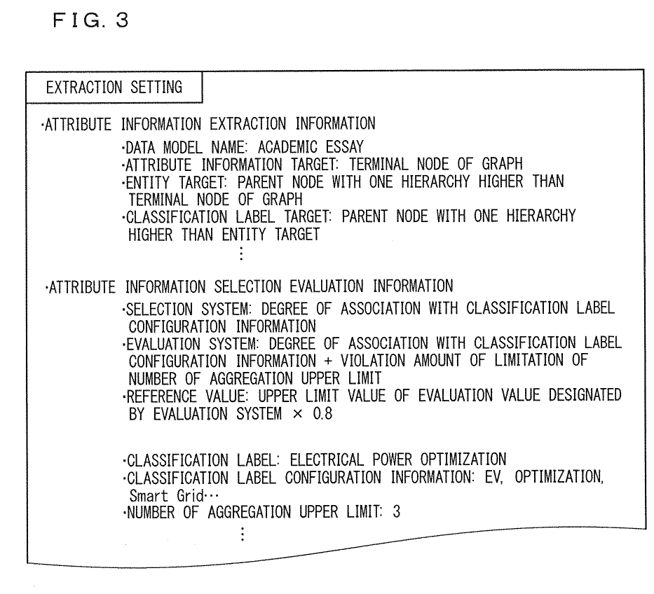

The setting receiving part 107 receives information regarding attribute information for which searchability and visibility are to be improved from among a huge amount of data in the data model as an extraction setting from a user, formats the extraction setting, and stores the extraction setting in the extraction setting storage part 103. The extraction setting is broadly divided into two pieces of information of attribute information extraction information and attribute information selection evaluation information as illustrated in FIG. 3.

The attribute information extraction information in FIG. 3 is information for obtaining a data model and extracting a collection of attribute information from a data model.

“Data model name” is a data model name in which the attribute information is to be extracted. Accordingly, the data model in which the attribute information is to be extracted in the data model in the data model information storage part 101 is designated.

“Attribute information target” is information indicating a reference of data treated as attribute information in the data of the data model.

“Entity target” is information indicating a reference of data treated as an entity associated with attribute information in the data of the data model. The entity is used for updating the data model for the selected attribute information.

“Classification label target” is information indicating a reference of data treated as a classification label usable for a viewpoint or a cutting point in searching the data model in the data of the data model. The classification label is data usable for a viewpoint or a cutting point in searching the data model, and some pieces of attribute information are collected by one classification label.

The attribute information selection evaluation information in FIG. 3 is information for selecting a partial collection of the attribute information as the selection attribute information from the collection of the attribute information or evaluating the selection attribute information.

“Selection system” is an index for determining attribute information to be preferentially selected. When the attribute candidate generation part 104 obtains the selection system and passes the selection system to the selection part 105, the selection part 105 uses the selection system as a policy of selecting the partial collection of the attribute information from the collection of the attribute information.

“Evaluation system” is an index for evaluating selected partial collections of the attribute information, that is to say, the selection attribute information. When the attribute candidate generation part 104 obtains the evaluation system and passes the evaluation system to the evaluation part 106, the evaluation part 106 uses the evaluation system as a policy of calculating the evaluation value of the selection attribute information.

“Reference value” is a reference of an evaluation value for determining a degree of an evaluation value calculated based on “evaluation system”. When the attribute candidate generation part 104 obtains the reference value, the attribute candidate generation part 104 determines the degree of the evaluation value calculated in the evaluation part 106 using the reference value.

“Classification label” is a classification label to be newly generated for an existing data model. The classification label is used when the classification label is newly generated for the existing data model in the data model edit part 108. The classification label may also be used when the selection part 105 selects the attribute information or when the evaluation part 106 evaluates the selection attribute information. For example, as described in the embodiment 2, when “electrical power optimization” is designated as the classification label, the selection part 105 may positively select the attribute information including “electrical power” or “optimization” included in “electrical power optimization”.

“Classification label configuration information” is information associated with “classification label” and is some pieces of information describing the classification label in detail. The classification label configuration information may also be used when the selection part 105 selects the partial collection of the attribute information as the selection attribute information or when the evaluation part 106 evaluates the selection attribute information. For example, since “EV”, “optimization”, and “Smart Grid”, are designated as the classification label configuration information in FIG. 3, the selection part 105 may positively select the attribute information associated with them.

“Aggregation upper limit number” is an upper limit value of the attribute information which the selection part 105 can select as the selection attribute information. When the selection attribute information is evaluated, the aggregation upper limit value is used when the evaluation part 106 performs evaluation using a violation amount of a limitation of a selection upper limit number.

For the setting receiving part 107, an input apparatus in which a user performs an input operation by a text may be used, or a communication apparatus receiving a form and an application inputted from a web browser may be used, for example. Furthermore, the setting receiving part 107 may transmit and receive information to and from an external apparatus by a file of a text, for example.

In the present embodiment 1 described above, the attribute information selection evaluation information received in the setting receiving part 107 includes the classification label and the classification label configuration information, thus corresponds to the label information associated with the classification label. In the present embodiments 1 and 2, it is sufficient that the attribute information selection evaluation information includes at least one of the classification label and the classification label configuration information. In the present specification, a term of at least one of A, B, C, . . . , and Z means any one of all combination of one or more items selected from group of A, B, C, . . . , and Z, for example.

### Extraction Setting Storage Part

The extraction setting storage part 103 is an information storage part holding information received in the setting receiving part 107, and holds information as illustrated in FIG. 3. The extraction setting storage part 103 outputs the information held in itself upon receiving an output instruction from the attribute information extraction management part 102, the attribute candidate generation part 104, and the data model edit part 108.

### Data Model Information Storage Part

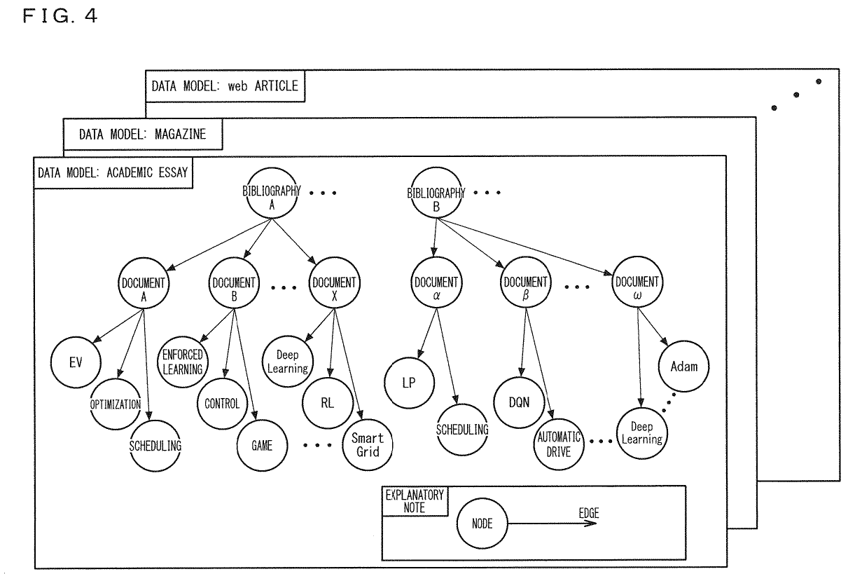

The data model information storage part 101 holds a plurality of data models to be monitored, and manages each data model by a data model name. FIG. 4 is a diagram illustrating an example of data held by the data model information storage part 101. In the example illustrated in FIG. 4, the data model information storage part 101 holds a data model having a data model name such as “academic essay”, “magazine”, and “web article”. A data format of each data model is not limited, but may be a text, a relational database, or a graph database, for example.

### Attribute Information Extraction Management Part

Inputted to the attribute information extraction management part 102 are attribute information extraction information held in the extraction setting storage part 103 and the data model to be extracted held in the data model information storage part 101. The attribute information extraction management part 102 extracts the collection of the attribute information from the data model to be extracted based on the attribute information extraction information and manages the collection thereof.

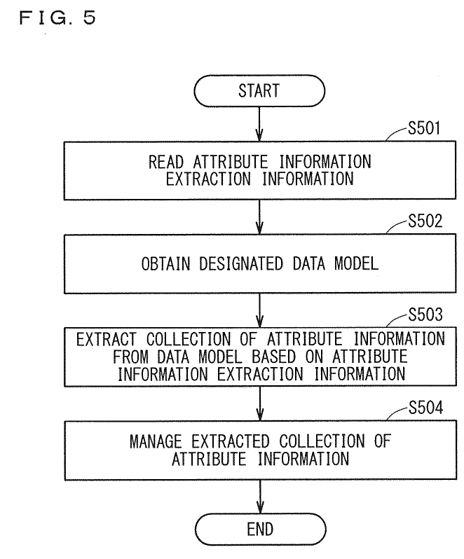

FIG. 5 is a flow chart illustrating a processing procedure of the attribute information extraction management part 102 according to the present embodiment 1.

In Step S501, the attribute information extraction management part 102 reads the attribute information extraction information illustrated in FIG. 3 from the extraction setting storage part 103, and obtains the data model name to be extracted from the attribute information extraction information.

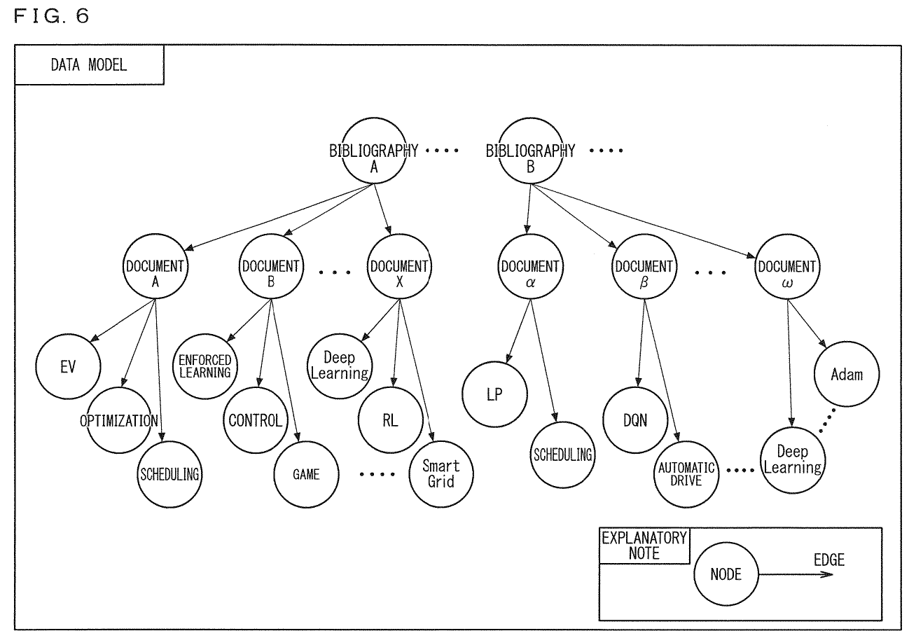

In Step S502, the attribute information extraction management part 102 obtains the data model designated by the data model name obtained in Step S501 from the data model information storage part 101. “Academic essay” is designated as the data model name in the attribute information extraction information in FIG. 3. Thus, when the data model information storage part 101 holds the information in FIG. 4, the attribute information extraction management part 102 obtains the data model having the data model name of “academic essay” as illustrated in FIG. 6 from the data model information storage part 101. The data model illustrated in the example in FIG. 6 is expressed by a graph data base format, and has a hierarchical structure made up of a node and an edge as illustrated in an explanatory note.

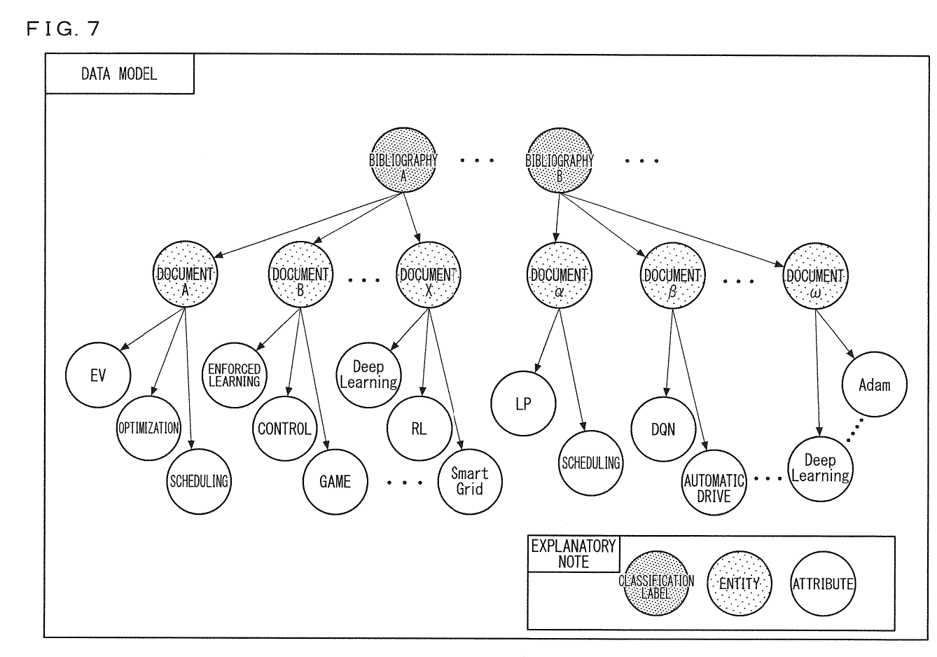

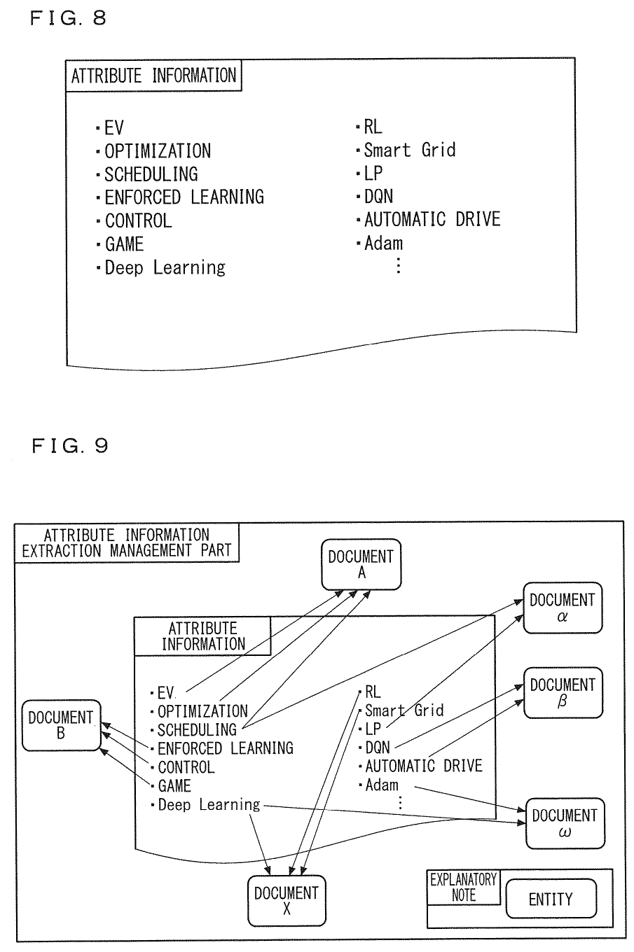

In Step S503, the attribute information extraction management part 102 extracts the collection of the attribute information from the data model obtained in Step S502. For example, the attribute information extraction management part 102 refers to an attribute information target, an entity target, and a classification label target included in the attribute information extraction information obtained in Step S501, and applies each element of the data model to an attribute, an entity, and a classification label as illustrated in FIG. 7. In the example illustrated in FIG. 7, the attribute is a terminal node of a graph, the entity is a parent node of the attribute, and the classification label is a parent node of the entity. Then, the attribute information extraction management part 102 extracts the information in the node classified into the attribute as the attribute information. FIG. 8 illustrates an example of the collection of the attribute information extracted from the name of the terminal node of the data model in FIG. 6.

In Step S504, the attribute information extraction management part 102 manages the collection of the attribute information extracted in Step S503 as illustrated in FIG. 8 together with the entity associated with each attribute information as illustrated in FIG. 9. According to the above operation, the attribute information extraction management part 102 can manage the collection of the attribute information and the entity associated with each attribute information regardless of the data format of the data model to be extracted. For management, a memory, for example, may be used, or a method of perpetuation in a database, for example, may be used.

### Attribute Candidate Generation Part

As illustrated in FIG. 1, the attribute candidate generation part 104 includes the selection part 105 and the evaluation part 106. However, the configuration is not limited thereto. It is also applicable that the selection part 105 and the evaluation part 106 are not included in the attribute candidate generation part 104 but are provided separately from the attribute candidate generation part 104.

Inputted to the attribute candidate generation part 104 are the collection of the attribute information managed by the attribute information extraction management part 102 and the attribute information selection evaluation information obtained from the extraction setting storage part 103. The attribute information selection evaluation information is used as an index of performing selection for the selection attribute information and an index of evaluating the selection attribute information. The attribute candidate generation part 104 can generate the attribute candidate from the plural pieces of selection attribute information based on the evaluation values of the plural pieces of selection attribute information obtained by repetition of selection for the selection attribute information and calculation of the evaluation value of the selection attribute information, and outputs the attribute candidate to the data model edit part 108.

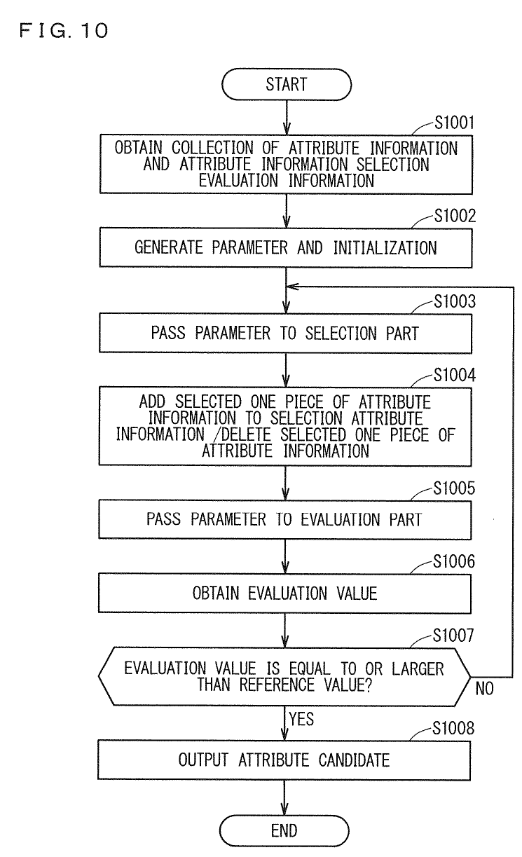

FIG. 10 is a flow chart illustrating a processing procedure of the attribute candidate generation part 104 according to the present embodiment 1.

In Step S1001, the attribute candidate generation part 104 obtains the collection of the attribute information managed by the attribute information extraction management part 102 as illustrated in FIG. 9. The attribute candidate generation part 104 obtains the attribute information selection evaluation information illustrated in FIG. 3 from the extraction setting storage part 103.

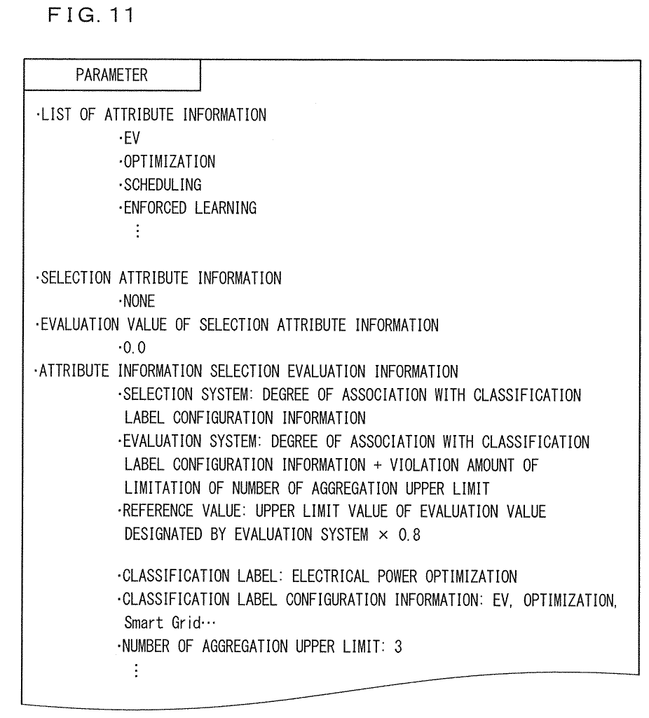

In Step S1002, the attribute candidate generation part 104 generates a parameter illustrated in FIG. 11 using the collection of the attribute information obtained in Step S1001 and the attribute information selection evaluation information obtained in Step S1001, and holds the parameter. The parameter includes “list of attribute information” in which the collection of the attribute information from which the entity is excluded from the collection of the attribute information illustrated in FIG. 9 is set. The parameter includes initialized “selection attribute information” and “evaluation value of attribute candidate” in the attribute information selection evaluation information and “attribute information selection evaluation information” illustrated in FIG. 3.

In Step S1003, the attribute candidate generation part 104 passes the parameter generated in Step S1002 to the selection part 105, and makes the selection part 105 select one piece of attribute information from the collection of the attribute information. Thus, the selection part 105 selects one piece of attribute information in accordance with “selection system” included in the parameter. Details of the selection processing in the selection part 105 are described hereinafter.

In Step S1004, the attribute candidate generation part 104 obtains one piece of attribute information selected in the selection part 105, and adds the selected attribute information to “selection attribute information” included in the parameter. When “selection attribute information” already includes one piece of attribute information selected in the selection part 105, the attribute candidate generation part 104 deletes one piece of attribute information selected in the selection part 105 from “selection attribute information”.

In Step S1005, the attribute candidate generation part 104 passes the parameter to the evaluation part 106, and makes the evaluation part 106 calculate the evaluation value for the partial collection of the attribute information included in “selection attribute information”, that is to say, the evaluation value for the selection attribute information. Thus, the evaluation part 106 calculates the evaluation value of the selection attribute information in accordance with “evaluation system” included in the parameter.

In Step S1006, the attribute candidate generation part 104 obtains the evaluation value calculated by the evaluation part 106, and updates “evaluation value of selection attribute information” included in the parameter by the evaluation value.

In Step S1007, the attribute candidate generation part 104 appropriately calculates the reference value based on “reference value” included in the parameter. Then, the attribute candidate generation part 104 determines whether the evaluation value obtained in Step S1006 is equal to or larger than the reference value. When the evaluation value is equal to or larger than the reference value, the process proceeds to Step S1008, and when the evaluation value is not equal to or larger than the reference value, the process returns to Step S1003.

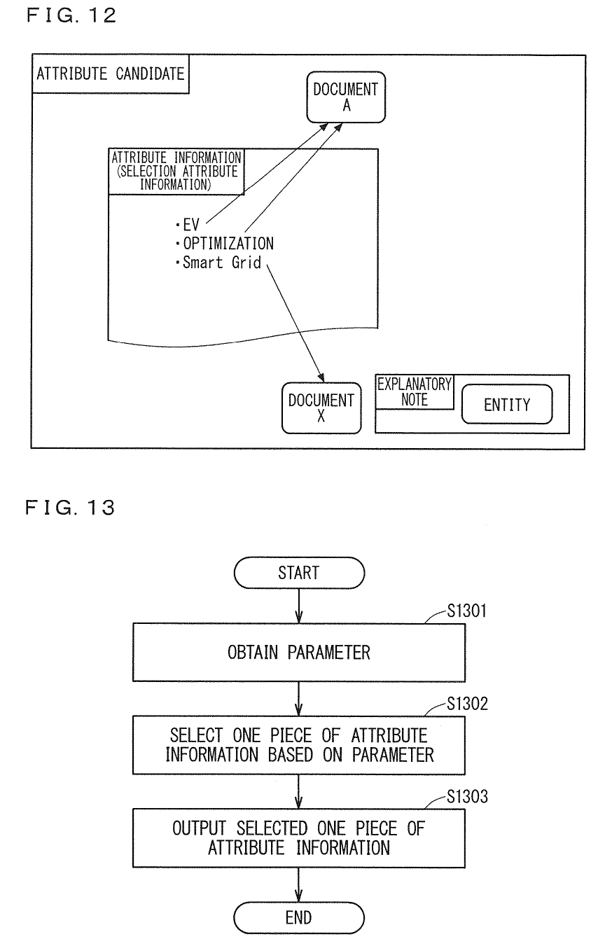

In Step S1008, the attribute candidate generation part 104 generates the attribute candidate by associating the partial collection of the attribute information included in “selection attribute information” of the parameter with the entity corresponding thereto, and outputs the attribute candidate to the data model edit part 108. For example, when the collection of the attribute information and the entity have a correspondence relationship as illustrated in FIG. 9 and the selection attribute information having the evaluation value equal to or larger than the reference value is “EV”, “optimization”, and “Smart Grid”, the attribute candidate generation part 104 outputs the attribute candidate as illustrated in FIG. 12.

Since the attribute candidate generation part 104 repeats the processing of Steps S1003 to S1007, a combination of the attribute information included in the selection attribute information is appropriately changed, and the evaluation values of the plural pieces of selection attribute information are calculated in a constat span. Subsequently, when the attribute candidate generation part 104 performs the processing of Step S1008, the selection attribute information having the evaluation value equal to or larger than a threshold value in the plural pieces of selection attribute information is generated as the attribute candidate in a constant span.

### Selection Part

The parameter supplied from the attribute candidate generation part 104 is inputted to the selection part 105. The selection part 105 selects one piece of attribute information from the collection of the attribute information of “list of attribute information” included in the parameter, and outputs the selected attribute information to the attribute candidate generation part 104. When the attribute candidate generation part 104 performs the processing procedure in FIG. 10 described above, the selection part 105 selects the partial collection of the attribute information from the collection of the attribute information as the selection attribute information.

FIG. 13 is a flow chart illustrating a processing procedure of the selection part 105 according to the present embodiment 1.

In Step S1301, the selection part 105 obtains the parameter as illustrated in FIG. 11 from the attribute candidate generation part 104.

In Step S1302, the selection part 105 selects one piece of attribute information from the collection of the attribute information set in “list of attribute information” in accordance with “selection system” included in the parameter obtained in Step S1301. In the selection system, the information of at least one of the classification label and the classification label configuration information is designated, and the attribute information associated with the designated information is preferentially selected. For example, since a degree of association with the classification label configuration information is designated in “selection system” in the parameter illustrated in FIG. 11, the attribute information associated with the classification label configuration information is preferentially selected.

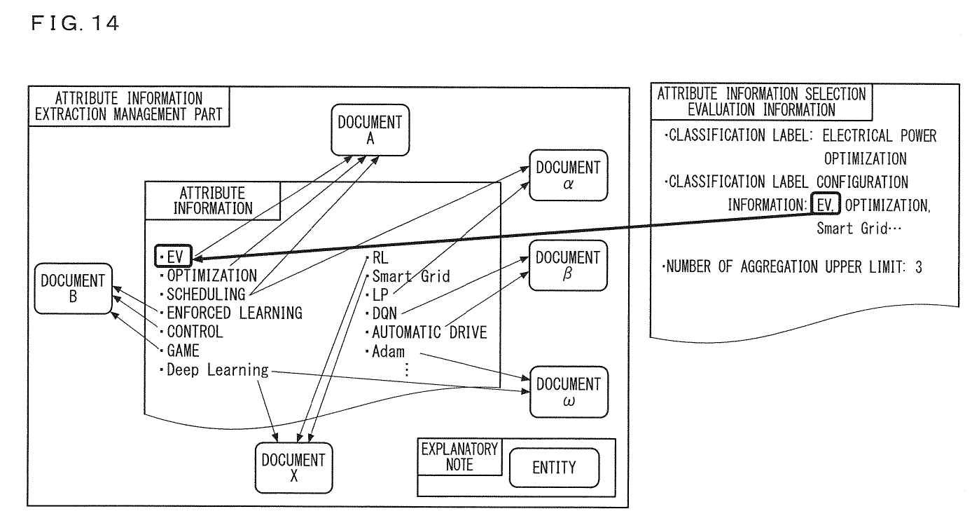

Since both the collection of the attribute information set in “list of attribute information” and the classification label configuration information include “EV” in the example illustrated in FIG. 14, the selection part 105 preferentially selects “EV” when “selection system” is designated as illustrated in FIG. 11. Although not illustrated in the diagrams, when the degree of association with the classification label in “selection system” is designated, the selection part 105 preferentially selects the attribute information associated with the classification label.

In Step S1303, the selection part 105 outputs one piece of attribute information selected in Step S1302 to the attribute candidate generation part 104. In the example illustrated in FIG. 14, both the collection of the attribute information set in “list of attribute information” and the classification label configuration information include “EV”, “optimization”, and “Smart Grid”. Thus, when the processing of Steps S1003 to S1007 in FIG. 10 is repeated, the partial collection of the attribute information of “EV”, “optimization”, and “Smart Grid” is preferentially selected as the selection attribute information.

### Evaluation Part

The parameter supplied from the attribute candidate generation part 104 is inputted to the evaluation part 106. The evaluation part 106 calculates the evaluation value of “selection attribute information” included in the parameter and outputs the evaluation value to the attribute candidate generation part 104.

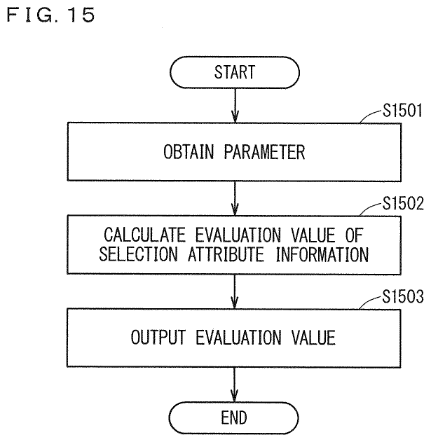

FIG. 15 is a flow chart illustrating a processing procedure of the evaluation part 106 according to the present embodiment 1.

In Step S1501, the evaluation part 106 obtains the parameter in which the selection of the selection part 105 is reflected from the attribute candidate generation part 104.

In Step S1502, the evaluation part 106 calculates the evaluation value of “selection attribute information” in accordance with “evaluation system” included in the parameter obtained in Step S1501. The evaluation system may be a system calculating the evaluation value using an index such as a degree of association between the attribute information included in the selection attribute information and the attribute information selection evaluation information included in the parameter, or may also be a system calculating the evaluation value using a weighting sum of some indexes.

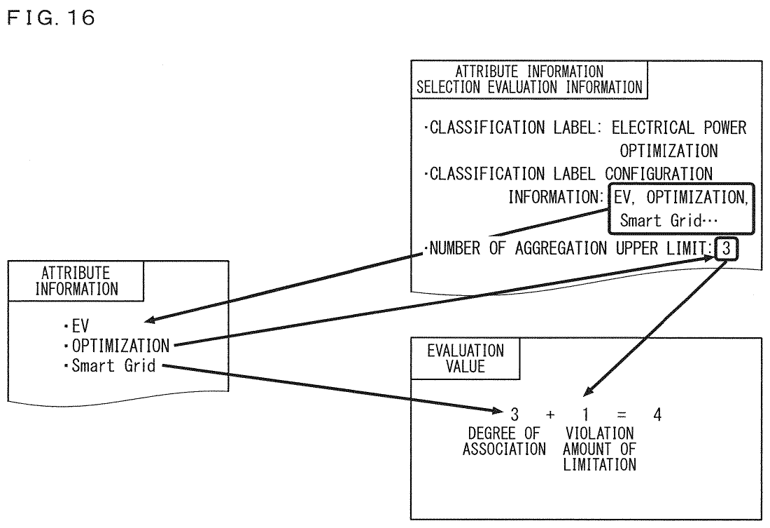

For example, in the parameter illustrated in FIG. 11, “degree of association with classification label configuration information+violation amount of limitation of number of aggregation upper limit” is designated as the index to “evaluation system”, and the evaluation part 106 calculates the evaluation value of the selection attribute information in accordance with this index. In the example of calculation of the evaluation value illustrated in FIG. 16, the evaluation part 106 calculates each of “degree of association with classification label configuration information and “violation amount of limitation of number of aggregation upper limit” as the indexes in “evaluation system”, and calculates a sum thereof as the evaluation value.

In the former “degree of association with classification label configuration information”, since “selection attribute information” includes “EV”, “optimization”, and “Smart Grid” designated in the classification label configuration information, the evaluation part 106 calculates “3” as the degree of association. In the latter “violence amount of limitation of number of aggregation upper limit”, the number of pieces of attribute information included in “selection attribute information” is “3”, and does not violate “3” as the number of aggregation upper limit. Thus, the evaluation part 106 calculates “1” as the violation amount of limitation. Although not illustrated in the diagrams, when the number of pieces of attribute information included in “selection attribute information” violates the number of aggregation upper limit, the evaluation part 106 calculates “0” or a negative value as the violation amount of limitation. Then, the evaluation part 106 calculates a sum (“4” in the example in FIG. 16) of a value calculated in the former “degree of association with classification label configuration information” and a value calculated in the latter “violence amount of limitation of number of aggregation upper limit” as the evaluation value.

In the above description, the evaluation part 106 calculates the evaluation value based on the degree of association corresponding to a degree of coincidence between the selection attribute information and the classification label configuration information. However, the configuration is not limited thereto. For example, the evaluation part 106 may calculate the evaluation value based on a difference between the selection attribute information and the classification label configuration information, which is inversely related to the degree of association thereof. The evaluation part 106 calculates the evaluation value based on the degree of association between the selection attribute information and the classification label configuration information herein. However, it is also applicable that the evaluation value is calculated based on the degree of association between the selection attribute information and the classification label or the difference between the selection attribute information and the classification label. That is to say, it is sufficient that the evaluation part 106 calculates the evaluation value based on the degree of association or the difference between the selection attribute information and the attribute information selection evaluation information.

In Step S1503, the evaluation part 106 outputs the evaluation value calculated in Step S1502 to the attribute candidate generation part 104.

### Data Model Edit Part

Inputted to the data model edit part 108 is information from the data model information storage part 101, the attribute candidate generation part 104, and the extraction setting storage part 103. The data model edit part 108 updates the data structure of the data model based on the inputted information. In the present embodiment 1, the data model edit part 108 newly generates the classification label based on the attribute information selection evaluation information or the attribute candidate. Then, the data model edit part 108 associates the generated classification label with the attribute information included in the attribute candidate, thereby updating the data model. That is to say, the data model edit part 108 updates the data model based on the attribute information selection evaluation information and the attribute candidate or based on the attribute candidate. The data model edit part 108 outputs the updated data model to the data model information storage part 101.

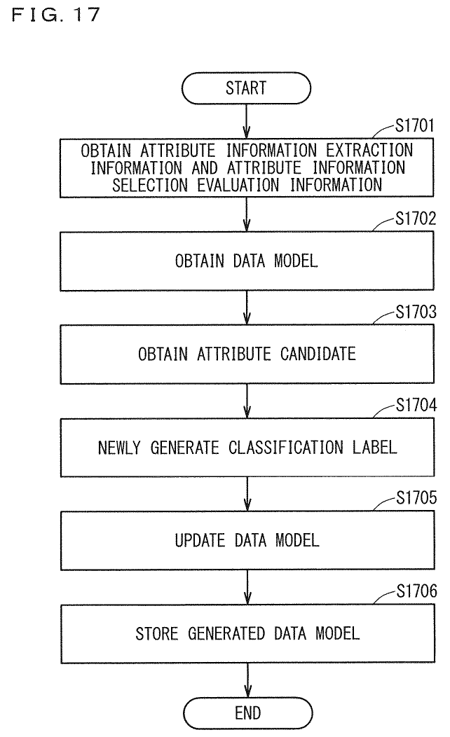

FIG. 17 is a flow chart illustrating a processing procedure of the data model edit part 108 according to the present embodiment 1.

In Step S1701, the data model edit part 108 obtains the attribute information extraction information and the attribute information selection evaluation information received by the setting receiving part 107 from the user and held in the extraction setting storage part 103.

In Step S1702, the data model edit part 108 obtains the data model name included in the attribute information extraction information obtained in Step S1701, and obtains the data model designated by the data model name from the data model information storage part 101.

In Step S1703, the data model edit part 108 obtains the attribute candidate from the attribute candidate generation part 104.

In Step S1704, the data model edit part 108 newly generates the classification label based on the attribute information selection evaluation information obtained in Step S1701. For example, when the attribute information selection evaluation information includes “classification label”, the data model edit part 108 newly generates the classification label using “classification label”. For example, when the attribute information selection evaluation information does not include “classification label”, the data model edit part 108 newly generates the classification label using the attribute information selection evaluation information other than “classification label” or the attribute information included in the attribute candidate. The attribute information selection evaluation information other than “classification label” is the classification label configuration information, for example.

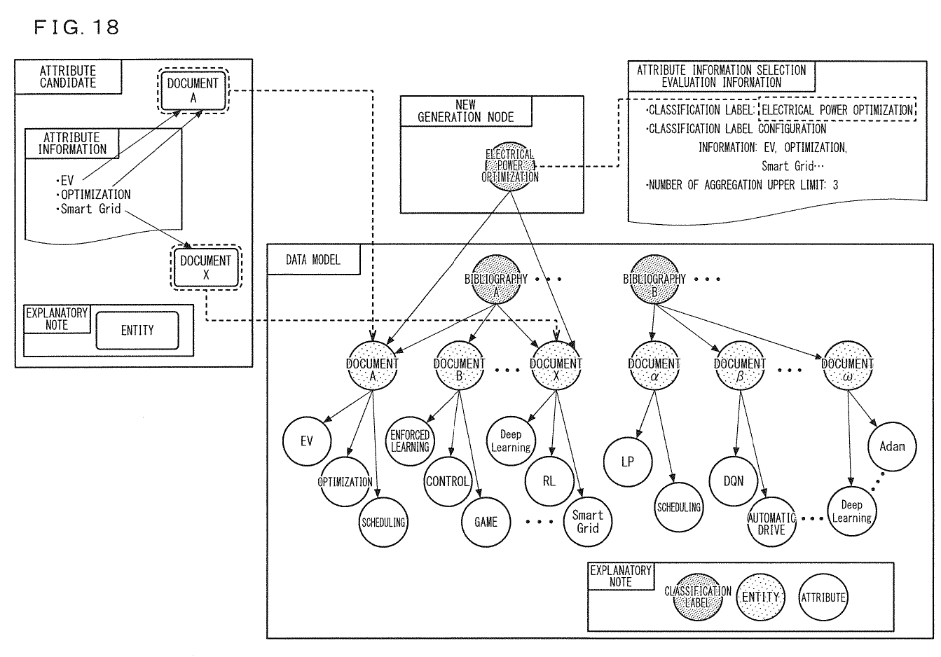

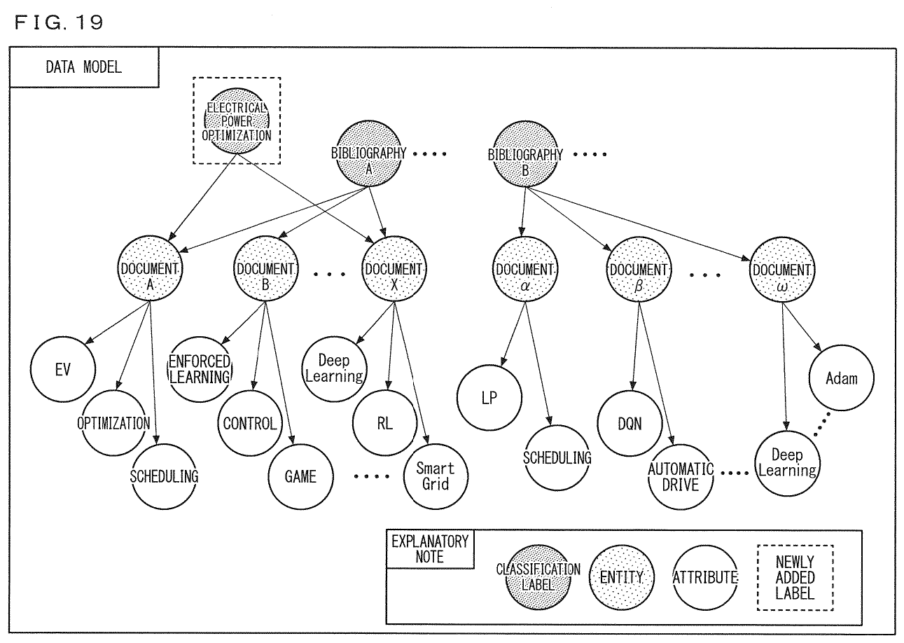

In Step S1705, the data model edit part 108 associates each attribute information included in the attribute candidate with the classification label generated in Step S1704 via the entity thereof, thereby updating the data model. FIG. 18 is a diagram illustrating an example of updating the data model. The data model in the example illustrated in FIG. 18 is the data model in the graph database format illustrated in FIG. 6. The data model edit part 108 connects “EV”, “optimization”, and “Smart Grid” as the attribute information included in the attribute candidate and the newly-generated classification label by an edge via “document A” and “document X” as entities of the attribute information. Accordingly, as illustrated in FIG. 19, the data model edit part 108 generates the new data model in which the new classification label and the attribute information included in the attribute candidate are associated with each other. The entity and the newly-generated classification label may be different hierarchies such as a parental relationship, or may also be the same hierarchy.

In Step S1706, the data model edit part 108 stores the data model generated in Step S1705 in the data model information storage part 101.

### Outline of Embodiment 1

According to the data model generation apparatus of the present embodiment 1, the collection of the attribute information is extracted from the data model, the attribute candidate having relationship is generated by repetition of selection for the selection attribute information and calculation of the evaluation value of the selection attribute information, and the data model is updated based on the information of the attribute candidate, for example. According to such a configuration, the data model with the hierarchy structure having visibility and searchability can be generated without the domain information such as the detailed classification condition, for example. When the data model edit part 108 newly generates the classification label based on the attribute candidate generated in the attribute candidate generation part 104 without using the attribute information selection evaluation information from outside such as a user, the data model having a known classification label which is not assumed by the user can be generated.

In the present embodiment 1, the selection part 105 performs selection for the selection attribute information based on the attribute information selection evaluation information including at least one of the classification label and the classification label configuration information. According to such a configuration, the selection for the selection attribute information can be performed in a reflection of a taste of a user.

In the present embodiment 1, the evaluation part 106 calculates the evaluation value of the selection attribute information based on the degree of association or the difference between the selection attribute information and the classification label configuration information. According to such a configuration, the selection attribute information can be evaluated, and furthermore, the attribute candidate can be generated in a reflection of a taste of a user.

### Embodiment 2

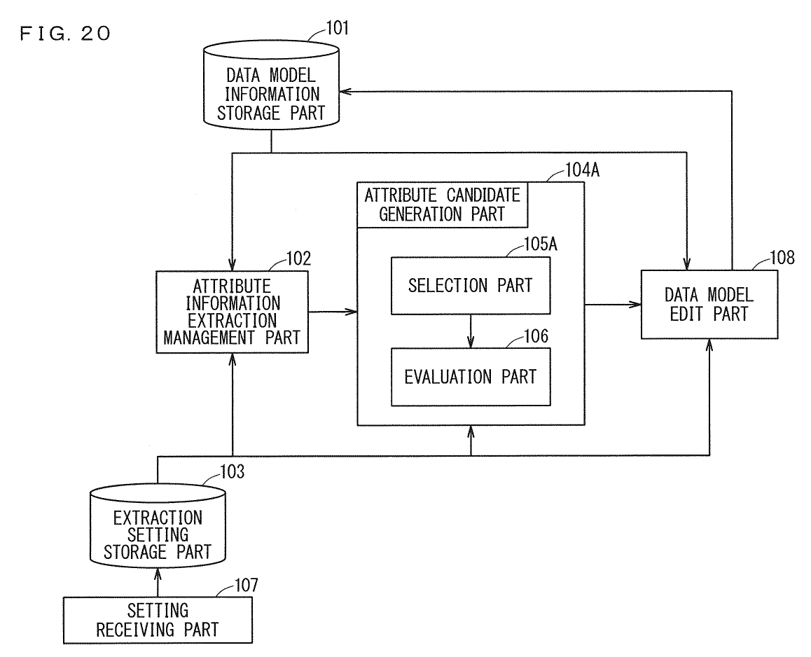

FIG. 20 is a diagram illustrating a configuration of a data model generation apparatus according to the present embodiment 2. The same or similar reference numerals as those described above will be assigned to the same or similar constituent element in the constituent elements according to the present embodiment 2, and the different constituent elements are mainly described hereinafter.

The configuration in FIG. 20 is similar to a configuration in which the attribute candidate generation part 104 and the selection part 105 in the configuration in FIG. 1 are changed to an attribute candidate generation part 104A and a selection part 105A, respectively.

Assumed as a first example is a case where “classification label” is included but “classification label configuration information” is absent in the attribute information selection evaluation information received in the setting receiving part 107 and held in the extraction setting storage part 103. In such a case, the attribute candidate generation part 104A generates “classification label configuration information” based on “classification label”, and supplies the parameter including “classification label configuration information” to the selection part 105A. The selection part 105A selects the partial collection of the attribute information as the selection attribute information from the collection of the attribute information based on “classification label configuration information” included in the parameter. The selection part 105A, not the attribute candidate generation part 104A, may generate “classification label configuration information” based on “classification label”.

Assumed as a second example is a case where “classification label” and “classification label configuration information” are absent in the attribute information selection evaluation information received in the setting receiving part 107 and held in the extraction setting storage part 103. In such a case, the selection part 105A selects the partial collection of the attribute information as the selection attribute information from the collection of the attribute information in accordance with a predetermined procedure. For example, the selection part 105A may select the selection attribute information at random, or may also select the selection attribute information using a heuristic as a predetermined procedure.

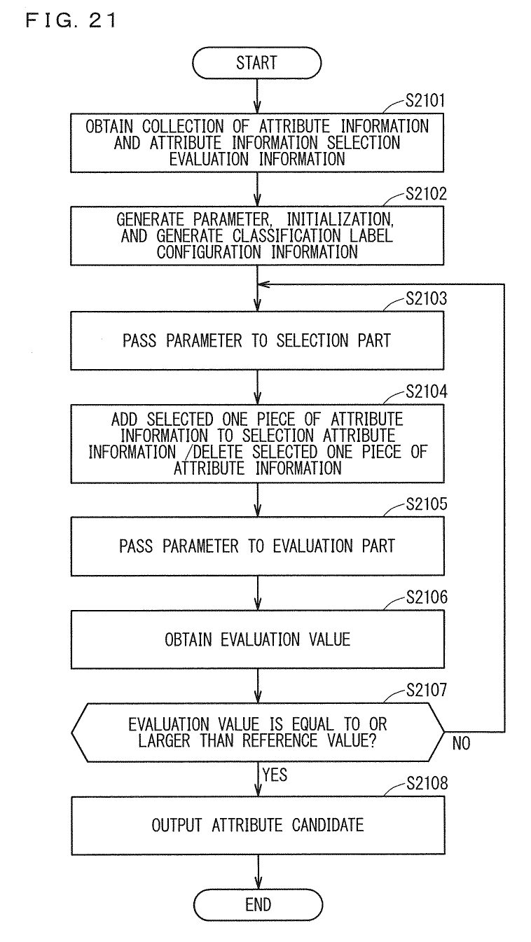

FIG. 21 is a flow chart illustrating a processing procedure of the attribute candidate generation part 104A according to the present embodiment 2. Since the processing in Steps S2101 and S2103 to S2108 in FIG. 21 is similar to the processing in Steps S1001 and S1003 to S1008 in FIG. 10, respectively, the processing in Step S2102 is mainly described hereinafter.

In Step S2102, the attribute candidate generation part 104A generates a parameter illustrated in FIG. 11 using the collection of the attribute information obtained in Step S2101 and the attribute information selection evaluation information obtained in Step S2101, and holds the parameter. When “classification label” is included but “classification label configuration information” is absent in the attribute information selection evaluation information, the attribute candidate generation part 104A generates “classification label configuration information” using “classification label” or the other attribute information selection evaluation information. In this manner, the attribute candidate generation part 104A complements “classification label configuration information”.

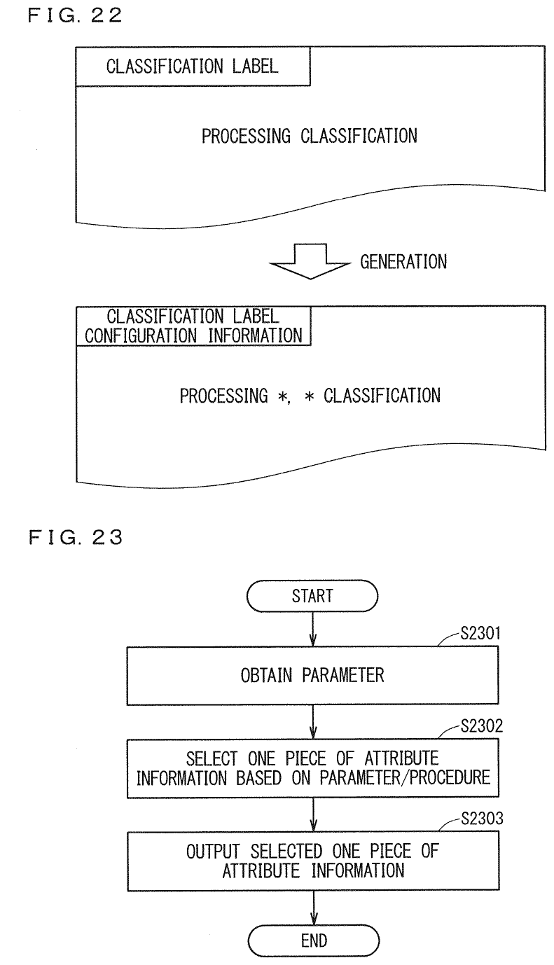

FIG. 22 is a diagram illustrating an example of complement processing of “classification label configuration information”. For example, when “processing classification” is set to the classification label, the attribute candidate generation part 104A generates a word of “processing” or “classification” from “processing classification”. Then, the attribute candidate generation part 104A generates some words including “processing” or “classification” as “classification label configuration information” of the parameter. A format of the generated classification label configuration information may be a word format or a format such as a regular expression.

In Step S2103, the attribute candidate generation part 104A passes the parameter generated in Step S2102 to the selection part 105A, and makes the selection part 105A select one piece of attribute information from the collection of the attribute information. Thus, the selection part 105A performs selection in accordance with “selection system” included in the parameter.

FIG. 23 is a flow chart illustrating a processing procedure of the selection part 105A according to the present embodiment 2. Since the processing in Step S2301 and S2303 in FIG. 23 is similar to that in Step S1301 and S1303 in FIG. 13, respectively, the processing in S2302 is mainly described hereinafter.

In Step S2302, the selection part 105A selects one piece of attribute information from the collection of the attribute information set in “list of attribute information” in accordance with “selection system” included in the parameter obtained in Step S2102. In the selection system, the information of at least one of the classification label and the classification label configuration information is designated, and the attribute information associated with the designated information is preferentially selected. The selection part 105A may select one piece of attribute information at random, or may also select one piece of attribute information using a heuristic, for example, depending on the designation of “selection system”.

### Outline of Embodiment 2

According to the data model generation apparatus of the present embodiment 2 described above, the selection part 105A performs selection for the selection attribute information based on the classification label configuration information generated from the classification label. According to such a configuration, even when “classification label configuration information” is absent, the selection part 105A can perform the selection for the selection attribute information. A unknown classification which is not assumed by a user, that is to say, a combination of unknown pieces of attribute information can be obtained.

In the present embodiment 2, the selection part 105A performs selection for the selection attribute information in accordance with a predetermined procedure, such as random or heuristic, for example. According to such a configuration, even when “classification label” and “classification label configuration information” are absent, the selection part 105A can perform the selection for the selection attribute information. A unknown classification which is not assumed by a user, that is to say, a combination of unknown pieces of attribute information can be obtained. When the heuristic is used, reduction of the number of trial running until the data model conforming to a taste of a user is generated can be expected more than a case of using random.

### Embodiment 3

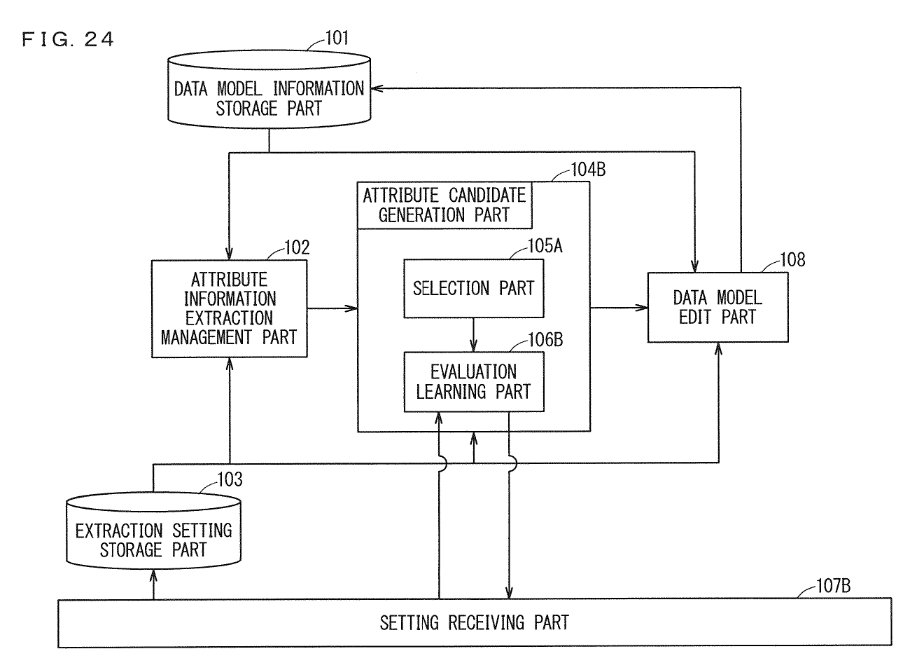

FIG. 24 is a diagram illustrating a configuration of a data model generation apparatus according to the present embodiment 3. The same or similar reference numerals as those described above will be assigned to the same or similar constituent element in the constituent elements according to the present embodiment 3, and the different constituent elements are mainly described hereinafter.

The configuration in FIG. 24 is similar to a configuration in which the attribute candidate generation part 104A, the evaluation part 106, and the setting receiving part 107 in the configuration in FIG. 20 are changed to an attribute candidate generation part 104B, an evaluation learning part 106B, and a setting receiving part 107B, respectively.

The setting receiving part 107B includes the function of the setting receiving part 107 described in the embodiment 1, a function of presenting at least a part of the parameter including the selection attribute information to the user, and a function of receiving feedback to the selection attribute information from the user. The feedback to the selection attribute information includes designation of the selection attribute information to be set to the attribute candidate, for example.

The evaluation learning part 106B learns the evaluation value using the feedback to the selection attribute information received in the setting receiving part 107B and the selection attribute information as learning data, and calculates the evaluation value based on the selection attribute information and the learning result. The learning is machine learning (training) such as deep learning, for example, the learning result is a learned model, for example, and the learning data is training data, for example.

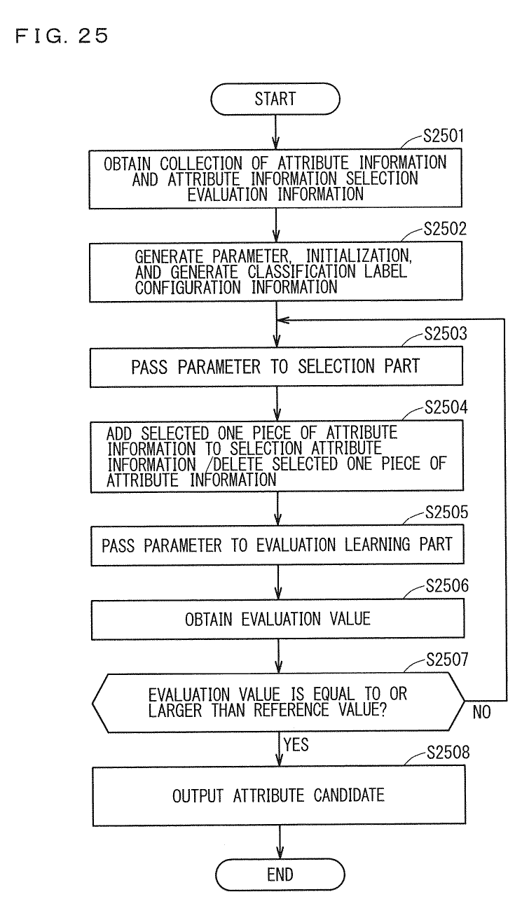

FIG. 25 is a flow chart illustrating a processing procedure of an attribute candidate generation part 104B according to the present embodiment 3. Since the processing in Steps S2501 to S2504 and S2506 to S2508 in FIG. 25 is similar to the processing in Steps S2101 to S2104 and S2106 to S2108, respectively, the processing in Step S2505 is mainly described hereinafter.

In Step S2505, the attribute candidate generation part 104B passes the parameter to the evaluation learning part 106B, and makes the evaluation learning part 106B calculate the evaluation value for the partial collection of the attribute information included in “selection attribute information”. Thus, the evaluation learning part 106B calculates the evaluation value as described hereinafter.

Firstly, the evaluation learning part 106B passes at least a part of the parameter including the selection attribute information to the setting receiving part 107B, and the setting receiving part 107B presents at least the part thereof to the user, and receives feedback to the selection attribute information from the user.

The evaluation learning part 106B learns the evaluation value corresponding to the relationship between the feedback and the selection attribute information using the feedback to the selection attribute information received in the setting receiving part 107B and the selection attribute information as the learning data. Then, the evaluation learning part 106B calculates the evaluation value of the selection attribute information based on the selection attribute information and the learning result.

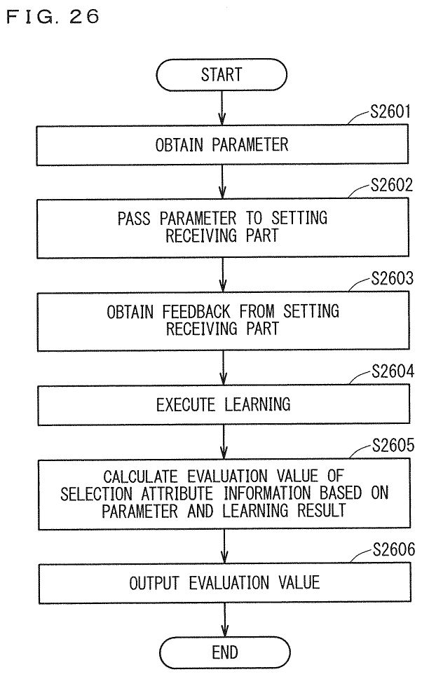

FIG. 26 is a flow chart illustrating a processing procedure of the evaluation learning part 106B according to the present embodiment 3.

In Step S2601, the evaluation learning part 106B obtains the parameter including “selection attribute information” from the attribute candidate generation part 104B.

In Step S2602, the evaluation learning part 106B passes at least a part of the parameter obtained in Step S2601 to the setting receiving part 107B. At least a part of the parameter includes “selection attribute information” and at least a part of “attribute information selection evaluation information”. At least a part of “attribute information selection evaluation information” is information associated with the index designated in “evaluation system” of the parameter, and includes “classification label” and “classification label configuration information”, for example.

In Step S2603, the evaluation learning part 106B obtains the feedback to “selection attribute information” received from the user in the setting receiving part 107B from the setting receiving part 107B.

In Step S2604, the evaluation learning part 106B executes learning on the evaluation value of the selection attribute information using “selection attribute information” and the feedback obtained in Step S2603 as the learning data. The learning in the evaluation learning part 106B may be learning performing weighting of reflecting a time in which the feedback is obtained from the setting receiving part 107B in the evaluation value. The time in which the feedback is obtained may be a time taken for the user to input the feedback to the setting receiving part 107B. In this case, for example, the weighing can be changed depending on whether the user determines the feedback immediately or considers the feedback for a long time. The time in which the feedback is obtained may be a time from when the data model generation apparatus is put into operation until when the user inputs the feedback to the setting receiving part 107B. In this case, for example, the weighting of the feedback inputted after a long period of time since the data model generation apparatus is operated can be made to larger than the weighting of the feedback inputted after a short period of time since the data model generation apparatus is operated.

Alternatively, in Step S2604, the learning in the evaluation learning part 106B may be learning performing weighting of reflecting attribute of the user whose feedback is received by the setting receiving part 107B in the evaluation value. The attribute of the user includes at least one of a position of the user, an experience in an assigned duty, suitability for the assigned duty, and whether or not the user is a skilled person. Accordingly, weighting of feedback of a user as an experienced person can be made to larger than weighting of feedback of a user as a freshman, for example.

The evaluation learning part 106B may perform a pre-learning using history information as a group of “selection attribute information” and feedback thereto. Accordingly, the evaluation learning part 106B can appropriately calculate the evaluation value for “selection attribute information” without feedback from the user after the learning.

In Step S2605, the evaluation learning part 106B calculates the evaluation value for “selection attribute information” included in at least a part of the parameter based on at least a part of the parameter including “selection attribute information” and the learning result obtained in Step S2604.

In Step S2606, the evaluation learning part 106B outputs the evaluation value calculated in Step S2605 to the attribute candidate generation part 104B.

### Outline of Embodiment 3

According to the data model generation apparatus in the present embodiment 3 described above, learned is the evaluation value using the feedback to the selection attribute information presented outside such as the user and the selection attribute information as the learning data, and calculated is the evaluation value based on the selection attribute information and the learning result. According to such a configuration, the selection attribute information can be evaluated in a reflection of a taste of the user without the feedback from the user after learning.

### Modification Example

Learning and calculation of the evaluation value in the evaluation learning part 106B is not limited to learning and calculation described in the embodiment 3. For example, the evaluation learning part 106B may learn the evaluation value using the classification label and the attribute candidate associated in the past as the learning data. Then, the evaluation learning part 106B may calculate a degree of correspondence between the classification label and the selection attribute information as the evaluation value based on the classification label included in the attribute information selection evaluation information received in the setting receiving part 107B, the selection attribute information, and the learning result. Even in such a configuration, the selection attribute information can be evaluated in a reflection of a taste of the user without the feedback from the user after learning.

The evaluation learning part 106B may learn the evaluation value using not the classification label and the attribute candidate associated in the past but the classification label and the selection attribute candidate associated in the past as the learning data. For example, it is applicable that the evaluation learning part 106B converts each attribute information of the selection attribute information into a feature vector, and learns a non-linear approximate function making a relationship of a distance between the vectors correspond to a degree of the evaluation value, thereby learning the evaluation value.

In the embodiment 3, the evaluation learning part 106B calculates the evaluation value by performing learning based on the feedback to the selection attribute information presented outside. However, the configuration is not limited thereto. For example, when the feedback to the selection attribute information presented outside is the evaluation value from the user, the evaluation part 106 described in the embodiment 1 may use the evaluation value from the user as it is.

### Embodiment 4

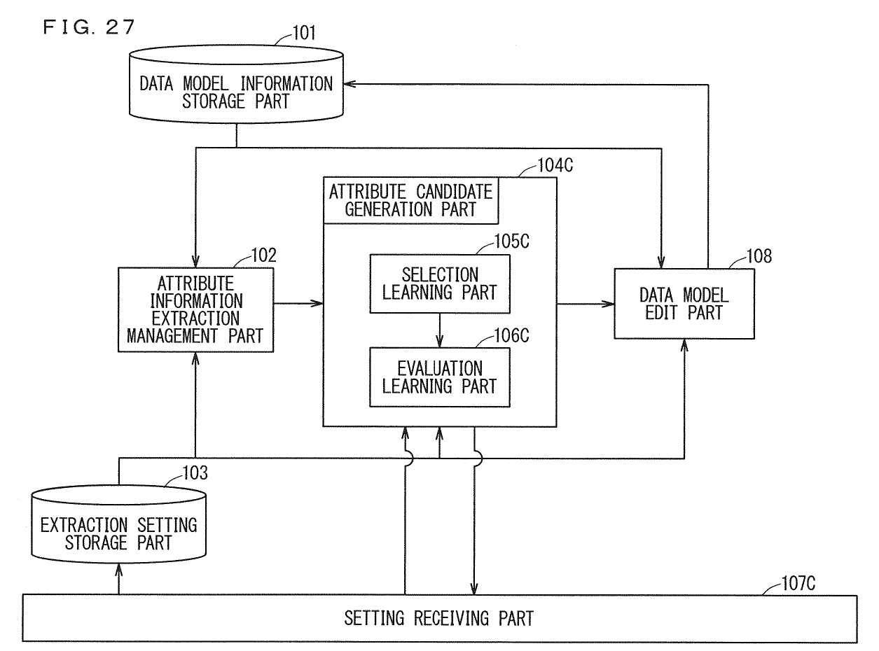

FIG. 27 is a diagram illustrating a configuration of a data model generation apparatus according to the present embodiment 4. The same or similar reference numerals as those described above will be assigned to the same or similar constituent element in the constituent elements according to the present embodiment 4, and the different constituent elements are mainly described hereinafter.

The configuration in FIG. 27 is similar to a configuration in which the attribute candidate generation part 104B, the selection part 105A, the evaluation learning part 106B, and the setting receiving part 107B in the configuration in FIG. 24 are changed to an attribute candidate generation part 104C, a selection learning part 105C, an evaluation learning part 106C, and a setting receiving part 107C, respectively.

The evaluation learning part 106C has the function of the evaluation learning part 106B according to the embodiment 3 and a loop function feeding back the evaluation value of the selection attribute information to the selection learning part 105C.

The setting receiving part 107C has the function of the setting receiving part 107B described in the embodiment 3, a function of presenting a monitoring control screen expressed in the attribute information to a user, a function of receiving an operation of the user on the monitoring control screen, and a function of receiving plant specific information including a context of a process of processing in a plant expressed in the attribute information.

The selection learning part 105C performs at least one of first learning, second learning, and third learning described hereinafter. Described hereinafter is an example that the selection learning part 105C performs all of the first learning, the second learning, and the third learning.

### First Learning

The selection learning part 105C learns selection for the selection attribute information using past selection attribute information fed back from the evaluation learning part 106C and the evaluation value of the selection attribute information as the learning data, and performs selection for the selection attribute information based on the collection of the attribute information and the learning result.

### Second Learning

The selection learning part 105C learns selection for the selection attribute information using an operation history of the user on the monitoring control screen as the learning data, and performs selection for the selection attribute information based on the collection of the attribute information and the learning result.

### Third Learning

The selection learning part 105C learns selection for the selection attribute information using the plant specific information as the learning data, and performs selection for the selection attribute information based on the collection of the attribute information and the learning result.

The selection learning part 105C and the evaluation learning part 106C automatically performs selection and evaluation for the selection attribute information after the sufficient learning. Accordingly, after the learning, selection and evaluation for the selection attribute information conforming to a taste of a user can be performed, and furthermore, the attribute candidate conforming to a taste of a user can be generated without the feedback from the user.

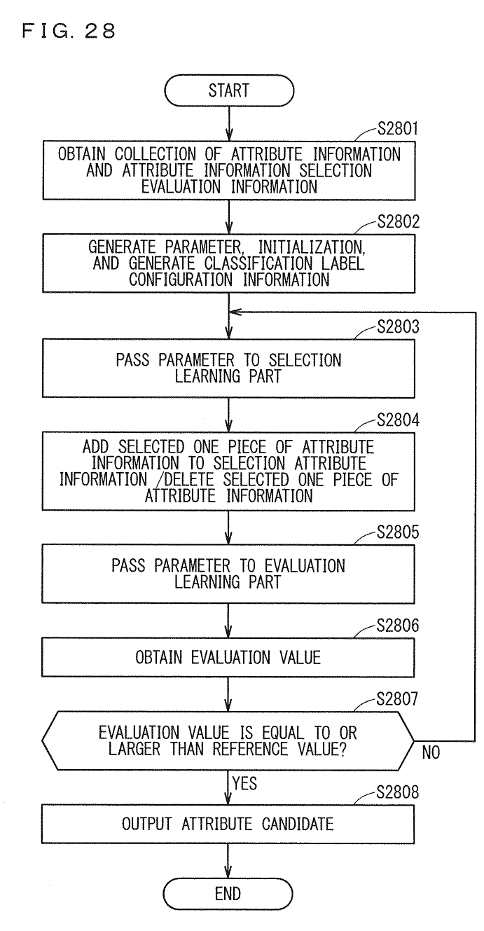

FIG. 28 is a flow chart illustrating a processing procedure of the attribute candidate generation part 104C according to the present embodiment 4. Since the processing in Steps S2801, S2802, and S2804 to S2808 in FIG. 28 is similar to the processing in Steps S2501, S2502, and S2504 to S2508, the processing in Step S2803 is mainly described hereinafter.

In Step S2803, the attribute candidate generation part 104C passes the parameter generated in Step S2802 to the selection learning part 105C, and makes the selection learning part 105C select one piece of attribute information from the collection of the attribute information. Since the attribute candidate generation part 104C includes the information of designating whether or not the learning is performed in the parameter, the selection learning part 105C and the evaluation learning part 106C can selectively perform learning in Step S2803 and Step S2805.

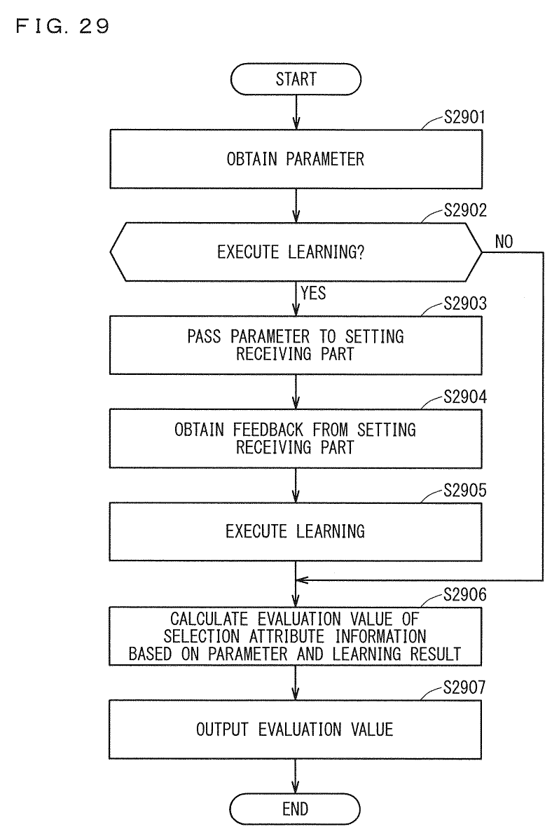

FIG. 29 is a flow chart illustrating a processing procedure of the evaluation learning part 106C according to the present embodiment 4. Since the processing in Steps S2901 and S2903 to S2907 in FIG. 29 is similar to the processing in Steps S2601 and S2602 to S2606 in FIG. 26, respectively, the processing in Step S2902 is mainly described hereinafter.

In Step S2902, the evaluation learning part 106C determines whether learning is executed based on the information of designating whether or not learning is performed, the information included in the parameter obtained in Step S2901. When it is determined that the learning is executed, the process proceeds to Step S2903, and when it is determined that the learning is not executed, the process proceeds to Step S2906.

After Step S2906, in Step S2907, the evaluation learning part 106C outputs the evaluation value calculated in Step S2906. The evaluation value outputted from the evaluation learning part 106C is used for updating “evaluation value of selection attribute information” of the parameter in the attribute candidate generation part 104C, and is further outputted to the selection learning part 105C.

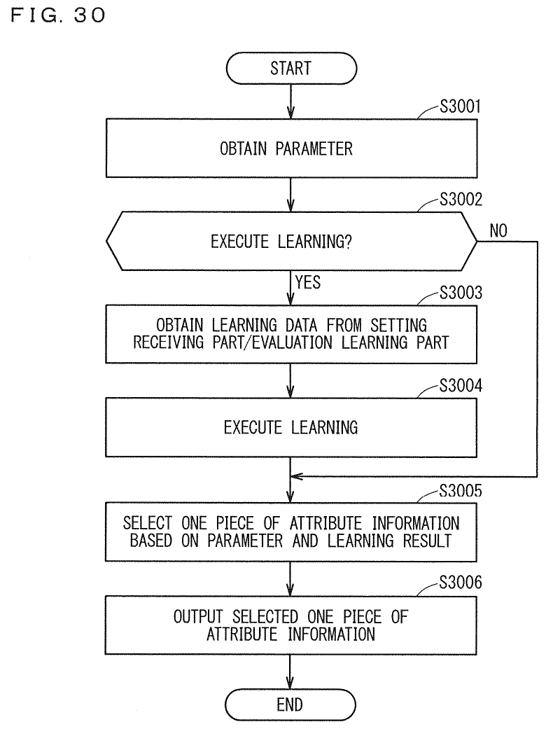

FIG. 30 is a flow chart illustrating a processing procedure of the selection learning part 105C according to the present embodiment 4. Since the processing in Steps S3001 and S3006 in FIG. 30 is similar to the processing in Steps S2301 and S2303 in FIG. 23, respectively, the processing in Steps S3002 to S3005 is mainly described hereinafter.

In Step S3002, the selection learning part 105C determines whether learning is executed based on the information of designating whether or not learning is performed, the information included in the parameter obtained in Step S3001. When it is determined that the learning is executed, the process proceeds to Step S3003, and when it is determined that the learning is not executed, the process proceeds to Step S3005.

In Step S3003, the selection learning part 105C obtains the evaluation value of “evaluation value of selection attribute information” included in the parameter as the learning data as the feedback from the evaluation learning part 106C. When the setting receiving part 107C receives the operation history of the user on the monitoring control screen and the plant specific information, the selection learning part 105C obtains the operation history and the plant specific information as the learning data from the setting receiving part 107C.

In Step S3004, the selection learning part 105C learns selection for the selection attribute information using the learning data obtained in Step S3003. Learned according to this learning is tendency of the partial collection of the attribute information considered to easily increase the evaluation value of “selection attribute information”.

In Step S3005, the selection learning part 105C selects one piece of attribute information considered to easily increase the evaluation value from the collection of the attribute information based on the collection of the attribute information set to “list of attribute information” of the parameter and the learning result obtained in Step S3004.

### Outline of Embodiment 4

According to the data model generation apparatus in the present embodiment 4 described above, learned is selection for the selection attribute information using past selection attribute information which has been fed back and the evaluation value of the selection attribute information as the learning data, and performed is selection for the selection attribute information based on the collection of the attribute information and the learning result. According to such a configuration, the attribute information considered to easily increase the evaluation value can be preferentially selected without the feedback from the user after learning.

In the present embodiment 4, learned is selection for the selection attribute information using the operation history of the user on the monitoring control screen expressed in the attribute information as the learning data, and performed is selection for the selection attribute information based on the collection of the attribute information and the learning result. According to such a configuration, learning can be performed using the operation history as a type of domain information. Thus, know-how in an operation of a monitoring control system can be reflected in the selection of the selection attribute information.

In the present embodiment 4, learned is selection for the selection attribute information using the plant specific information expressed in the attribute information as the learning data, and performed is selection for the selection attribute information based on the collection of the attribute information and the learning result. According to such a configuration, learning can be performed using the plant specific information as a type of domain information. Thus, know-how in the operation of the monitoring control system can be reflected in the selection of the selection attribute information.

### Modification Example

Although the selection learning part 105C automatically performs selection for the selection attribute information in the embodiment 4, the configuration is not limited thereto. For example, in the manner similar to <first learning part> described above, the selection learning part 105C firstly learns selection for the selection attribute information using past selection attribute information and the evaluation value of the selection attribute information as the learning data, and selects the candidate of the selection attribute information based on the collection of the attribute information and the learning result.

Then, the setting receiving part 107C may present the candidate of the selection attribute information selected in the selection learning part 105C to the user and receive the feedback to the candidate of the selection attribute information from the user. The selection learning part 105C may select the selection attribute information based on the feedback to the candidate of the selection attribute information received in the setting receiving part 107C. According to such a configuration, the selection for the selection attribute information conforming to a taste of the user can be semi-automatically performed.

### Embodiment 5

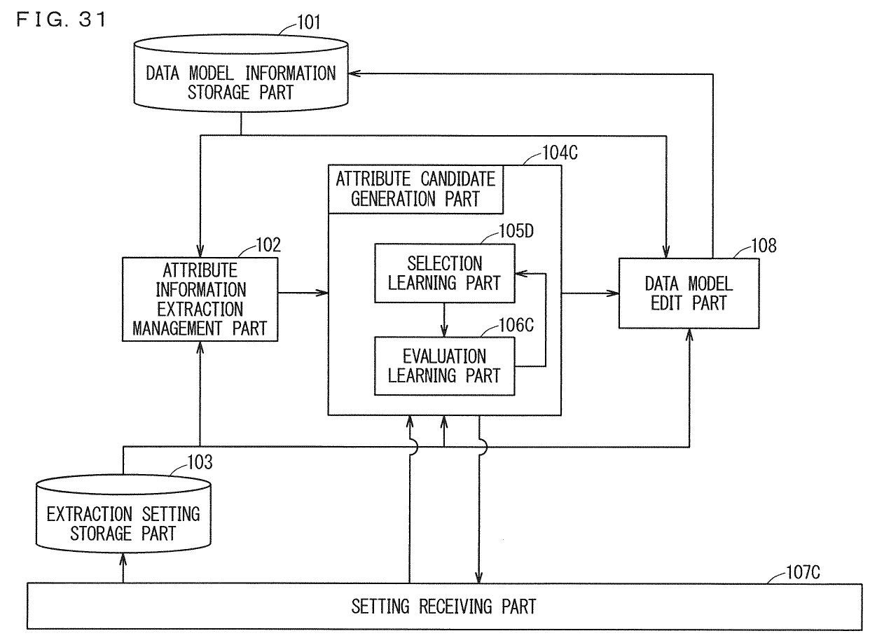

FIG. 31 is a diagram illustrating a configuration of a data model generation apparatus according to the present embodiment 5. The same or similar reference numerals as those described above will be assigned to the same or similar constituent element in the constituent elements according to the present embodiment 5, and the different constituent elements are mainly described hereinafter.

The configuration in FIG. 31 is similar to a configuration in which the selection learning part 105C according to the configuration in FIG. 27 is changed to the selection learning part 105D.

The selection learning part 105D has the function of the selection parts 105 and 105A according to the embodiments 1 and 2 and the function of the selection learning part 105C according to the embodiment 3. The selection learning part 105D has a function of performing selection for the selection attribute information in consideration of increase and decrease of the evaluation value of newly generated “selection attribute information”. That is to say, the selection learning part 105D can preferentially select the attribute information not to reduce the evaluation value of “selection attribute information”.

When the selection learning part 105D selects the attribute information in consideration of increase and decrease of the evaluation value of “selection attribute information”, the evaluation learning part 106C does not execute learning, that is to say, proceeds with processing in Steps S2902 to S2906, and calculates the evaluation value using the learning result. Then, in Step S2907, the evaluation learning part 106C outputs the evaluation value calculated in Step S2906 not to the attribute candidate generation part 104C but to the selection learning part 105D.

Inputted to the selection learning part 105D are the parameter supplied from the attribute candidate generation part 104C and the evaluation value fed back from the evaluation learning part 106C. The selection learning part 105D selects one piece of attribute information from “list of attribute information” included in the parameter based on the parameter and the evaluation value. In the manner similar to the embodiment 4, when the setting receiving part 107C obtains the domain information of the operation history of the user or the plan specific information, for example, the domain information may be inputted to the selection learning part 105D.

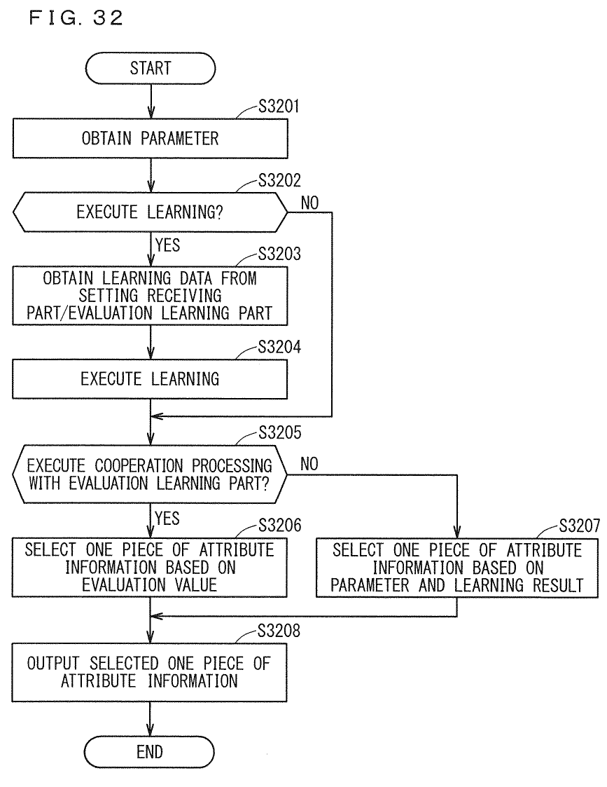

FIG. 32 is a flow chart illustrating a processing procedure of the selection learning part 105D according to the present embodiment 5. Since the processing in Steps S3201 to S3204, S3207, and S3208 in FIG. 32 is similar to the processing in Steps S3001 to S3004, S3005, and S3006 in FIG. 30, respectively, the processing in Steps S3205 and S3206 is mainly described hereinafter.

In Step S3205, the selection learning part 105D refers to the parameter obtained in Step S3201, and determines whether or not cooperation processing of selecting one piece of attribute information in cooperation with the evaluation learning part 106C is performed. The cooperation processing may be determined to be performed with a fixed probability. When it is determined that the cooperation processing is performed, the process proceeds to Step S3206, and when it is determined that the cooperation processing is not performed, the process proceeds to Step S3207.

In Step S3206, the selection learning part 105D selects some pieces of attribute information from the collection of the attribute information included in “list of attribute information” of the parameter, and inputs the selected attribute information to the evaluation learning part 106C. The selection learning part 105D may select some pieces of attribute information using a heuristic, for example. The evaluation learning part 106C calculates the evaluation value of the selection attribute information using some pieces of attribute information as the selection attribute information without executing learning in the evaluation learning part 106C. Then, the selection learning part 105D selects one piece of attribute information based on the calculated evaluation value. For example, the selection learning part 105D checks increase and decrease of the evaluation value of the selection attribute information, and selects one piece of attribute information maximizing the evaluation value of the selection attribute information.

### Outline of Embodiment 5

Since any one of the plural pieces of selection attribute information similar to each other within a constant range tends to be selected in the learning in the embodiment 4, when the evaluation value of the selection attribute information beyond the constant range is largest, appropriate selection attribute information may not be obtained in some cases. In contrast, since the selection learning part 105D appropriately uses the function similar to the selection parts 105 and 105A in the present embodiment 5, when the selection attribute information beyond the constant range, that is to say, the selection attribute information which cannot be obtained in the learning is appropriate, the selection attribute information can be used. In other words, since the selection learning part 105D can use the selection attribute information such as a mutation obtained in a genetic algorithm, a possibility of using truly optimal selection attribute information can be increased.

### Another Modification Example

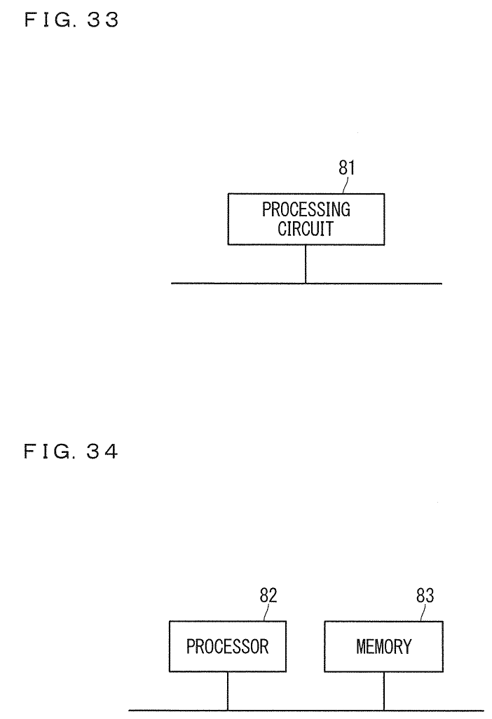

The attribute information extraction management part 102, the attribute candidate generation part 104, the selection part 105, the evaluation part 106, and the data model edit part 108 in FIG. 1 described above are referred to as “the attribute information extraction management part 102 etc.”. The attribute information extraction management part 102 etc. is achieved by a processing circuit 81 illustrated in FIG. 33. That is to say, the processing circuit 81 includes: the attribute information extraction management part 102 extracting the collection of attribute information from the data model to be monitored; the selection part 105 selecting at least one partial collection of the attribute information as at least one piece of selection attribute information from the collection of the attribute information; the evaluation part 106 calculating the evaluation value of the selection attribute information; the attribute candidate generation part 104 generating the attribute candidate from the plural pieces of selection attribute information based on the evaluation value of the plural pieces of selection attribute information obtained by repetition of selection for the selection attribute information and calculation of the evaluation value of the selection attribute information; and the data model edit part 108 updating the data model based on the label information associated with the classification label representing the attribute candidate and the attribute candidate or based on the attribute candidate. Dedicated hardware may be applied to the processing circuit 81, or a processer executing a program stored in a memory may also be applied. Examples of the processor include a central processing unit, a processing device, an arithmetic device, a microprocessor, a microcomputer, or a digital signal processor (DSP).

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. A function of each part of the attribute information extraction management part 102 etc. may be achieved by circuits to which the processing circuit is dispersed, or a function of each part may also be collectively achieved by one processing circuit.

When the processing circuit 81 is the processor, the functions of the attribute information extraction management part 102 etc. are achieved by a combination with software etc. Software, firmware, or software and firmware, for example, fall under the software etc. The software etc. is described as a program and is stored in a memory. As illustrated in FIG. 34, a processor 82 applied to the processing circuit 81 reads out and executes a program stored in the memory 83, thereby achieving the function of each unit. That is to say, the data model generation apparatus includes the memory 83 for storing a program to resultingly execute steps of, when executed by the processing circuit 81: extracting the collection of attribute information from the data model to be monitored; selecting at least one partial collection of the attribute information as at least one piece of selection attribute information from the collection of the attribute information; calculating the evaluation value of the selection attribute information; generating the attribute candidate from the plural pieces of selection attribute information based on the evaluation value of the plural pieces of selection attribute information obtained by repetition of selection for the selection attribute information and calculation of the evaluation value of the selection attribute information; and updating the data model based on the label information associated with the classification label representing the attribute candidate and the attribute candidate or based on the attribute candidate. In other words, this program is also deemed to make a computer execute a procedure or a method of the attribute information extraction management part 102 etc. Herein, the memory 83 may be a non-volatile or volatile semiconductor memory such as a random access memory (RAM), a read only memory (ROM), a flash memory, an electrically programmable read only memory (EPROM), or an electrically erasable programmable read only memory (EEPROM), a hard disk drive (HDD), a magnetic disc, a flexible disc, an optical disc, a compact disc, a mini disc, a digital versatile disc (DVD), or a drive device of them, or any storage medium which is to be used in the future.

Described above is the configuration in which each function of the attribute information extraction management part 102 etc. is achieved by one of the hardware and the software, for example. However, the configuration is not limited thereto, but also applicable is a configuration of achieving a part of the attribute information extraction management part 102 etc. by dedicated hardware and achieving another part of them by software, for example. For example, the function of the attribute information extraction management part 102 can be achieved by the processing circuit 81 as the dedicated hardware, and the function of the other units can be achieved by the processing circuit 81 as the processor 82 reading out and executing the program stored in the memory 83.

As described above, the processing circuit 81 can achieve each function described above by the hardware, the software, or the combination of them, for example.

The data model generation apparatus may be made up of a single apparatus, or may also be made up of a plurality of combined apparatuses. Elements of the data model generation apparatus may be made up by making a computer execute a program or hardware which does not execute a program. That is to say, software may perform processing, or hardware may perform signal processing.

The data model generation apparatus described above can also be applied to a data model generation system including a data model generation part as a data model generation apparatus other than the setting receiving parts 107, 107B, and 107C and a setting receiving part having the same function as the setting receiving parts 107, 107B, and 107C and communicable with the data model generation part via Internet, for example.

Each embodiment and each modification example can be arbitrarily combined, or each embodiment and each modification example can be appropriately varied or omitted.

The foregoing description is in all aspects illustrative and does not restrict the disclosure. It is therefore understood that numerous modification examples not illustrated can be devised.

### EXPLANATION OF REFERENCE SIGNS

102 attribute information extraction management part, 104, 104A, 104B, 104C attribute candidate generation part, 105, 105A, selection part, 105C, 105D selection learning part, 106 evaluation part, 106B, 106C evaluation learning part, 107, 107B, 107C setting receiving part, 108 data model edit part.

1. A data model generation apparatus, comprising:
setting receiving circuitry receiving label information including at least one of a classification label and classification label configuration information associated with the classification label from outside;
attribute information extraction management circuitry extracting a collection of attribute information from a data model to be monitored;
selection circuitry selecting at least one partial collection of the attribute information as at least one piece of selection attribute information from the collection of the attribute information based on the label information which has been received;
evaluation circuitry calculating an evaluation value of the selection attribute information;
attribute candidate generation circuitry generating an attribute candidate from the plural pieces of selection attribute information based on the evaluation value of the plural pieces of selection attribute information obtained by repetition of selection for the selection attribute information and calculation of the evaluation value of the selection attribute information; and
data model edit circuitry updating the data model based on the label information associated with the classification label representing the attribute candidate and the attribute candidate or based on the attribute candidate.

2. (canceled)

3. The data model generation apparatus according to claim 1, wherein
the setting receiving circuitry receives the label information including the classification label from outside,
classification label configuration information associated with the classification label is generated based on the classification label included in the label information which has been received, and
the selection circuitry performs selection for the selection attribute information based on the classification label configuration information.

4. The data model generation apparatus according to claim 1, wherein
the selection circuitry performs selection for the selection attribute information in accordance with a predetermined procedure.

5. The data model generation apparatus according to claim 1, wherein
the selection circuitry is selection learning circuitry learning selection for the selection attribute information using the selection attribute information in a past and the evaluation value of the selection attribute information as learning data, selecting candidate of the selection attribute information based on the collection of the attribute information and a learning result, and performing selection for the selection attribute information based on feedback received in the setting receiving circuitry to the candidate of the selection attribute information presented outside.

6. The data model generation apparatus according to claim 1, wherein
the selection circuitry is selection learning circuitry learning selection for the selection attribute information using the selection attribute information in a past and the evaluation value of the selection attribute information as learning data and performing selection for the selection attribute information based on the collection of the attribute information and a learning result.

7. The data model generation apparatus according to claim 1, wherein
the setting receiving circuitry receives an operation history of a user to a monitoring control screen expressed in the attribute information, and
the selection circuitry is selection learning circuitry learning selection for the selection attribute information using the operation history as learning data and performing selection for the selection attribute information based on the collection of the attribute information and a learning result.

8. The data model generation apparatus according to claim 1, wherein
the setting receiving circuitry receives plant specific information including a context of a process of processing in a plant expressed in the attribute information, and
the selection circuitry is selection learning circuitry learning selection for the selection attribute information using the plant specific information as learning data and performing selection for the selection attribute information based on the collection of the attribute information and a learning result.

9. The data model generation apparatus according to claim 1, wherein
the evaluation circuitry calculates the evaluation value based on a degree of association or a difference between the selection attribute information and the label information.

10. The data model generation apparatus according to claim 1, wherein
the setting receiving circuitry receives feedback to the selection attribute information presented outside from the outside, and
the evaluation circuitry calculates the evaluation value based on the feedback.

11. The data model generation apparatus according to claim 1, wherein
the setting receiving circuitry receives the label information including the classification label from outside, and
the evaluation circuitry is evaluation learning circuitry learning the evaluation value using the classification label and the attribute candidate associated in a past or the classification label and the selection attribute information associated in a past as learning data and calculating the evaluation value based on the classification label included in the label information which has been received, the selection attribute information, and a learning result.

12. The data model generation apparatus according to claim 10, wherein
the evaluation circuitry is evaluation learning circuitry learning the evaluation value using the feedback and the selection attribute information as learning data and calculating the evaluation value based on the selection attribute information and a learning result, and performs weighting of reflecting a time in which the feedback is obtained from the setting receiving circuitry in the evaluation value.

13. The data model generation apparatus according to claim 10, wherein
the evaluation circuitry is evaluation learning circuitry learning the evaluation value using the feedback and the selection attribute information as learning data and calculating the evaluation value based on the selection attribute information and a learning result, and performs weighting of reflecting attribute of a user as the outside whose feedback is received by the setting receiving circuitry in the evaluation value.

14. The data model generation apparatus according to claim 1, wherein
the data model edit circuitry newly generates the classification label based on the label information or the attribute candidate and associates the classification label which has been generated and the attribute information included in the attribute candidate, thereby updating the data model.

15. The data model generation apparatus according to claim 1, further comprising:
data model information storage circuitry holding the data model used in the attribute information extraction management circuitry and the data model updated in the data model edit circuitry; and
extraction setting storage circuitry holding the label information used in the data model edit circuitry.

16. A data model generation system, comprising:
data model generation circuitry; and
setting receiving circuitry communicable with the data model generation circuitry via Internet, wherein
the setting receiving circuitry receives label information including at least one of a classification label and classification label configuration information associated with the classification label from outside;
the data model generation circuitry includes:
attribute information extraction management circuitry extracting a collection of attribute information from a data model to be monitored;
selection circuitry selecting at least one partial collection of the attribute information as at least one piece of selection attribute information from the collection of the attribute information based on the label information which has been received;
evaluation circuitry calculating an evaluation value of the selection attribute information;
attribute candidate generation circuitry generating an attribute candidate from the plural pieces of selection attribute information based on the evaluation value of the plural pieces of selection attribute information obtained by repetition of selection for the selection attribute information and calculation of the evaluation value of the selection attribute information; and
data model edit circuitry updating the data model based on the label information associated with the classification label representing the attribute candidate and the attribute candidate or based on the attribute candidate, and
the data model generation circuitry receives the label information.

17. A method of generating a data model, comprising:
receiving label information including at least one of a classification label and classification label configuration information associated with the classification label from outside;
extracting a collection of attribute information from a data model to be monitored;
selecting at least one partial collection of the attribute information as at least one piece of selection attribute information from the collection of the attribute information based on the label information which has been received;
calculating an evaluation value of the selection attribute information;
generating an attribute candidate from the plural pieces of selection attribute information based on the evaluation value of the plural pieces of selection attribute information obtained by repetition of selection for the selection attribute information and calculation of the evaluation value of the selection attribute information; and
updating the data model based on the label information associated with the classification label representing the attribute candidate and the attribute candidate or based on the attribute candidate.
